(19) United States
(12) Patent Application Publication
(10) Pub. No.: US 2002/0059264 A1
(43) Pub. Date: May 16, 2002

(54) Method and system for the display of business data from multiple sources

(76) Inventors: Maureen Fleming, Natick, MA (US); Alejandro Trevino, Hartsdale, NY (US); Erik de Pee, Apeldoorn (NL); Joel Doran, Leusden (NL); Heinze Claus, Ermelo (NL); Henk Kuyer, Bilthoven (NL); Ronaldus Jozef Maria Tetteroo, Blazicuor (NL); Jan Berend Wissink, Amersfoort (NL)

Correspondence Address: BROMBERG & SUNSTEIN LLP, 125 SUMMER STREET, BOSTON, MA, 02110-1618, US

(21) Appl. No.: 09/771,356

(22) Filed: Jan. 26, 2001

Related U.S. Application Data
(63) Continuation-in-part of application No. 09/389,275, filed on Sep. 2, 1999.
Application No. 09/389,275 is a continuation of application No. 08/894,904, filed on Mar. 5, 1998, now abandoned.
(60) Provisional application No. 60/178,853, filed on Jan. 28, 2000.

(30) Foreign Application Priority Data
Mar. 4, 1996 (NL) PCT/NL96/00101

(51) Int. Cl. G06F 7/00

(52) U.S. Cl. 707/100

(57) ABSTRACT

A method for presenting business data using a computer system. Business data, which need not be part of a single data structure in any format, of at least one enterprise is associated with a business model. The business model has at least one indicator pertinent to performance of a business and at least one category identifying an aspect of the business to which the indicator may be pertinent. For each pair of indicator and category in the business model, there may exist a parameter, which is derivable from the business data and not necessarily pre-existing in such business data. Pursuant to a query that defines one or more indicator-category pairs, the business data is used to derive values of one or more parameters corresponding to the one or more indicator-category pairs in the query.

This application claims priority from United States provisional patent application Ser. No. 60/178,853, filed Jan. 28, 2000, entitled “Method and System for the Display of Data from Multiple Sources”. This application is a continuation-in-part of U.S. patent application Ser. No. 09/389,275, filed Sep. 2, 1999, entitled “Method and System for the Display of Data from Multiple Sources”, which is a continuation of U.S. patent application Ser. No. 08/894,904, filed Sep. 2, 1997 entitled “Method and System for the Display of Data from Multiple Sources” (abandoned Dec. 16, 1999), which claims priority from International patent application serial number PCT/NL96/00101, filed Mar. 4, 1996, having a priority date of Mar. 3, 1995. Each of the patent applications described in this paragraph is hereby incorporated by reference, in its entirety.

### FIELD OF THE INVENTION

This invention relates to data systems, and more particularly, to a system of requesting, retrieving, and displaying business data from at least one enterprise.

### BACKGROUND OF THE INVENTION

Data systems used by enterprises to support their business hold a wealth of information, and are utilized by managers to make business decisions. In today's fast paced, competitive and rapidly changing business market, decisions need to be made expeditiously based upon current information. Often, combining business data from multiple sources within an enterprise is required to make decisions. Moreover, sharing business data across enterprises and various companies may also be necessary to remain competitive, allowing decisions to be based on the events occurring in an entire market.

Business data is typically widely distributed in various databases across an enterprise where the databases have disparate database structures, thus complicating the retrieval and combination of the information in a display format desired by an end user. For example, in FIG. 1, a client user 5 may desire business data from one or more databases 3 within the enterprise where the databases are distributed across a network 1 and even across secondary networks 2 . The data must be collected, processed, and sent to the client user 5.

Traditional data systems that provide client users with information from such disparate data systems usually “get” data from multiple data systems, “process” the data, and “present” the resulting information to end users, as shown in FIG. 2. Data and data control is generally made within a single enterprise, with no communication between, for example, customers 2802, companies 2804, suppliers 2806, or partners 2808. Processing of data 2818 is typically designed for analytical purposes, and presentation of the data 2820 is usually geared to the management layers 2822 of an organization.

The traditional method to “get” information 2816 from multiple data systems is to load the data onto a secondary system, called a datawarehouse 2810. These systems are designed to manage information within a single enterprise. Traditional uses for datawarehouses 2810 are for historical analysis and to build and maintain a single repository for such things as a customer masterfile or financial accounting processes. Loading a datawarehouse 2810 causes significant delays between the entry of information into a data system and its availability to a client user who needs the information in order to make a decision.

More recently, another layer in the traditional “get” architecture 2816 has been introduced, which entails loading data from a datawarehouse 2810 to a datamart 2812 for grouping specific data into a data subset such that the data is more readily accessible for users needing data of the data subset. However, the datamart 2812 does not solve the underlying problem of gaining real-time access to source data.

In addition to the inability to gain rapid access to source data, a datawarehouse 2810 takes ownership of all data that passes through it. Enterprises wishing to share data with other enterprises will thus be hesitant to use such a system, as they lose long-term ownership to their own data. Furthermore, both the datawarehouse 2810 and the datamart 2812 must be maintained, adding additional expense.

Traditional “process” systems 2818 offer technologies that process data and deliver results into reports directed at financial accounting processes. These technologies either work with a single source database or they work with datawarehouses 2810. In order to process data, these systems move subsets of data into an analytical staging environment. Thus, the data is transferred from its original location and becomes stale and does not reflect real-time changes. These analytical staging environments are suitable for analysis of historic trends to yield decisions affecting the finances of the enterprise. Additionally, these analytical staging environments do not support large numbers of diverse end users, since the end reports are targeted to a specific need and the data cannot be tailored to the individual requirements of a large number of users.

Current “present” technologies 2820 include providing information in reports. Vendors in the reporting and business intelligence segment “present” information in the form of printed or electronic reports. They focus on information that happened in a previous period and are presented as a single report. Such “present” technology 2820 is limited for the following reasons.

Reports are typically forwarded to end users after a financial period closes. By this time, the ability to take action has already passed. Since changes to data represented in reports are not updated in real time, a manager or other user of the reported data may make important decisions based on data that is no longer valid.

Furthermore, because information in the report is stale, the ability of an individual client user to take action as trends happen is difficult if not impossible. For a particular end user who needs information on a micro level as opposed to the macro level provided in a report focused on financial accounting processes, custom analysis is required of the data in the datawarehouse or datamart. This custom analysis causes another delay in the retrieval of useful information for the end user. Compounding these problems is that a user cannot, after receiving a report, request additional information that in real time is combined with the current report to form a new report.

Appropriate solutions are needed that are built on an information foundation that breaks from the traditional Get-Process-Present architectures, which are simply too slow, and too focused on single enterprises and financial accounting processes to be suitable for high speed commerce requirements.

### SUMMARY OF THE INVENTION

In one embodiment of the invention, a system for presenting data derived from one or more databases is presented. The system has a model having at least one indicator and at least one category to which the indicator may be pertinent. For each indicator and category pair there may exist a parameter that is derivable from sources in the one or more data bases, the parameter not necessarily pre-existing therein. A projection engine receives a user query that defines one or more indicator-category pairs with respect to each of which a corresponding parameter value is desired. The user query is mapped to the model by a model engine, which provides a link between the model and the sources. One or more desired commands to the one or more databases for retrieving data from the sources is generated by a query engine. The model engine derives from the retrieved data each corresponding parameter value for each indicator-category pair.

In another embodiment of the invention, a method for presenting data, derived from one or more databases is presented. The one or more databases need not be part of a single data structure or have a specific format. A model is provided, having at least one indicator and at least one category to which the indicator may be pertinent. For each indicator and category pair there may exist a parameter, derivable from sources in the one or more data bases, the parameter not necessarily pre-existing therein. A link is provided by a model engine to the sources for determining the parameter for each indicator-category pair. A query is received that defines one or more indicator-category pairs with respect to each of which a corresponding parameter value is desired. The model engine is used to access the sources by a query engine and to derive from the sources each corresponding parameter value, whereupon each corresponding parameter value is reported.

In still another embodiment of the invention, a method for presenting business data using a computer system is presented. A business model is provided, the business model having at least one indicator pertinent to performance of a business and at least one category identifying an aspect of the business to which the indicator may be pertinent. For each indicator and category pair there may exist a parameter, derivable from the business data sources of at least one enterprise. The parameter does not necessarily pre-exist in such data, nor does the business data need to be part of a single data structure in any format. Paths are provided, in connection with the business model, to the sources in the data for determining the parameter for each indicator-category pair. A query is received that defines one or more indicator-category pairs with respect to each of which a corresponding parameter value is desired, whereupon the business model is used to derive the corresponding parameter value.

In yet another embodiment of the invention, a method for presenting business data using a computer system is presented. Business data of at least one enterprise is associated with a business model, the business model having at least one indicator Iᵢ (iεA, A={1, . . . , m, m a non-zero integer}) pertinent to performance of a business and at least one category Cⱼ(jεB, B={1, . . . , n, n a non-zero integer}) identifying an aspect of the business to which the indicator Iᵢ may be pertinent. For each pair {Iᵢ, Cⱼ} there may exist a parameter Pᵢⱼ, derivable from the business data, that is susceptible to change over time, and wherein a parameter set S={. . . , Pᵢⱼ, . . . } for all values of i and j for which a parameter Pᵢⱼ exists. In a first computer process distinct from any financial accounting processes of the at least one enterprise, and pursuant to a query that defines a result subset { . . . , Pᵣₛ, . . . }, rεA, sεB, of the parameter set S, the business data is used to derive values Pᵣₛ for all values of r and s.

In still yet another embodiment of the invention, a method for presenting business data using a computer system is presented. Business data of at least one enterprise is associated with a business model, the business model having at least one indicator Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Iᵢ may be pertinent. For each category and indicator value combination V=V_{I}∪ V_{C}, where V_{I}={. . . , I_{α}, . . . } where αεA and V_{C}={. . . , C_{β}, . . . } where βεB, there may exist a parameter P_{V}, derivable from the business data, that is susceptible to change over time, and wherein there exists a parameter set S={. . . , P_{V},. . . } for all V for which a parameter P_{V} exists. In a first computer process of the at least one enterprise, and pursuant to a query that defines a result subset {. . . , P_{V} , . . } of the parameter set S, where W is an element of the set of all V's for which a parameter P_{V} exists, the business data is used to derive parameter values P_{W}.

In another embodiment of the invention, a computer system for presenting business data is presented. The system has a business context engine for associating the business data of at least one enterprise with a business model, the business model having at least one indicator Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Iᵢ may be pertinent. For each pair {Iᵢ, Cⱼ} there may exist a parameter Pᵢⱼ derivable from the business data, that is susceptible to change over time, and wherein there exists a parameter set S={. . . , Pᵢⱼ, . . . } for all values of i and j for which a parameter Pᵢⱼ exists.

The business context engine, in a computer process distinct from any financial accounting processes of the at least one enterprise, and pursuant to a query that defines a result subset {. . . , Pᵣₛ, . . . }, rεA, sεB, of the parameter set S, uses the business data to derive parameter values Pᵣₛ for all values of r and s.

In still another embodiment of the invention, a method for creating a business model using an architect module is presented. The model is based on business data of at least one enterprise. At least one indicator Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Iᵢ may be pertinent is entered, forming a two dimensional grid. The two dimensional grid has the at least one indicator Iᵢ located on a first axis of the grid and the at least one category Cⱼ located on a second axis of the grid, so that each node on the two dimensional grid represents a pair {Iᵢⱼ, Cⱼ}.

In another embodiment of the invention, a method for presenting business data using a computer system is presented. Business data, which need not be part of a single data structure in any format, of at least one enterprise is associated with a business model. The business model has at least one indicator pertinent to performance of a business and at least one category identifying an aspect of the business to which the indicator may be pertinent. For each indicator and category pair there may exist a parameter, derivable from the business data and not necessarily pre-existing in such business data. In a first computer process, and pursuant to a query that defines one or more indicator-category pairs, the business data is used to derive values of one or more parameters corresponding to the one or more indicator-category pairs in the query.

The methods as expressed above can be adapted as program products, wherein the performance of the method may be written as computer code which may be placed on a computer readable medium. These method claims may also be combined in hardware, software, or in firmware.

In a related embodiment, the methods expressed above may operate in a network environment wherein the method steps are performed on a server, the query having been received from a client. The network may be the Internet. In a another related embodiment, information derived from parameter values are outputted to a network device, the output permitting the display of the information at the network device. In outputting, the output may permit the display of the information in a format that allows selectable display, which may be according to hierarchical level of data from which the information is derived. The output may also permit the display of the information in a format that allows, for a parameter, selecting an instance of a category, whereby data of a category related to the instance of the category is displayed. In various embodiments, in outputting, the output may permit the display of a graphical indication of a current trend of a parameter. The graphical indication may be used for graphical control. Graphical control may be actuated by graphically selecting the graphical indication, and may be dependent on the trend displayed by the graphical indication. The graphical indication may control the display of related data. A template may be associated with the business model, for displaying the one or more parameters, the template including an arrangement for displaying data in a format that permits selectable display of related data from which the one or more parameters are derived. The template with the parameters may be transmitted to a client via a network for display of the template in a browser.

### BRIEF DESCRIPTION OF THE DRAWINGS

The foregoing features of the invention will be more readily understood by reference to the following detailed description, taken with reference to the accompanying drawings, in which:

FIG. 1 is a diagram of a data system spread over various networks and databases;

FIG. 2 is a diagram of a traditional data system (prior art);

FIG. 3 is a diagram of a data system for retrieving business data from at least one enterprise according to one embodiment of the invention;

FIG. 4 is a screen image of a typical page view;

FIG. 5 is a screen image of a typical monitor;

FIG. 6 is a block diagram of a system showing a business context engine, an architect module, and a gateway.

FIG. 7 is a diagram showing the business model serving as a link between the data sources and the analytical software;

FIG. 8 is an example of a business model;

FIG. 9 is a diagram showing how elements are used to form a business model;

FIG. 10 is a flowchart of the steps used in creating a business model;

FIG. 10A is a flowchart showing a use of the business model;

FIG. 11 is a graphical display that can be used in creating the business model;

FIG. 12 are four panels in the graphical display of FIG. 11, which include the grid that represents the business model;

FIG. 13 is a graphical display for adding or editing indicators;

FIG. 14 is a graphical display for importing tables from a database;

FIG. 15 is a graphical display for linking a category to the database;

FIG. 16 is a graphical display for linking a connection to the database;

FIG. 17 is a block diagram of a system for retrieving business data from at least one enterprise utilizing the business model, including a model engine and query engine, which are components of the business context engine, and a projection engine, which is a component of the gateway.

FIG. 18 is a block diagram of the model manager showing how the business model is implemented and utilized by the model manager in accordance with one embodiment of the invention.

FIG. 19 is a flowchart of the steps used by the model manager to automatically retrieve business data requested by the client user;

FIG. 20 is an example of a business model;

FIG. 21 is a table, entitled “month costs & turnover,” in the database associated with the business model of FIG. 20;

FIG. 22 is a table in the database associated with the business model of FIG. 20, entitled “client costs & turnover”;

FIG. 23 is a table in the database associated with the business model of FIG. 20, entitled “month table”;

FIG. 24 is a table in the database associated with the business model of FIG. 20, entitled “office table”;

FIG. 25 is a table in the database associated with the business model of FIG. 20, entitled “working unit table”;

FIG. 26 is a table associated with the business model of FIG. 20, formed in implementing relationships created by the model manager, entitled “indicator table”;

FIG. 27 is a table associated with the business model of FIG. 20, formed in implementing relationships created by the model manager, entitled “indicator property table”;

FIG. 28 is a table associated with the business model of FIG. 20, formed in implementing relationships created by the model manager, entitled “aggregation table”;

FIG. 29 is a table associated with the business model of FIG. 20, formed in implementing relationships created by the model manager, entitled “aggregation differential level table”;

FIG. 30 is a table associated with the business model of FIG. 20, formed in implementing relationships created by the model manager, entitled “differential level table”;

FIG. 31 is a table associated with the business model of FIG. 20, formed in implementing relationships created by the model manager, entitled “category table”;

FIG. 32 is a table associated with the business model of FIG. 20, formed in implementing relationships created by the model manager, entitled “allocation table”;

FIG. 33 is a block diagram of a system which allows client users to access and retrieve business data through the business context engine;

FIG. 34 is a flowchart of steps used in rendering data at a client, based on an template defined by a server using JavaScript;

FIG. 35 is a sample template containing the keyword #SESSIONDATA;

FIG. 36 is a file showing the result of merging the sample template in FIG. 35 with session data for a simple table;

FIG. 37 is the table created using the file of FIG. 36;

FIG. 38 is an enlarged view of the report explorer panel in page view;

FIG. 39 is an enlarged view of the results panel in page view;

FIG. 40 is a graphic display of a standard page in page view;

FIG. 41 is a graphic display of a dimensions page in page view;

FIG. 42 is a graphic display of a totals page in page view;

FIG. 43 is an enlarged view of the report panel in page view;

FIG. 44 is a graphic display allowing a user to log in and simultaneously request a personalized monitor;

FIG. 45 is an example of a business model; and

FIG. 46 is a monitor based on the business model of FIG. 45.

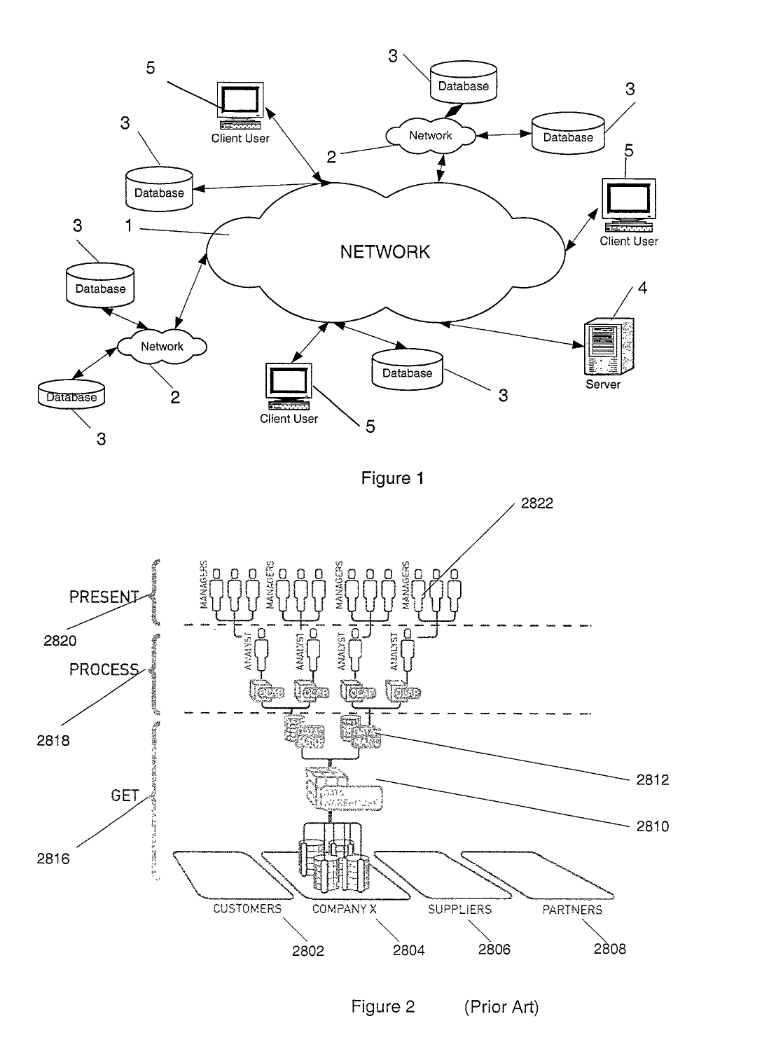

### DETAILED DESCRIPTION OF SPECIFIC EMBODIMENTS

As used in this description, and the accompanying claims, the following terms shall have the meanings indicated, unless the context otherwise requires. The term “browser” as used herein means a software application program that is designed to facilitate browsing of data or programs on a network, such as the World Wide Web, by finding desired data and displaying it in understandable form. A web browser is a client program that uses HTTP or another similar language to request services from another computer somewhere in the Internet. The term “client/server” as used herein means the relationship between two computer programs in which one program, the client, makes a service request from another program, the server, which fulfills the request. Relative to the Internet, the Web browser is a client program that requests services from another computer somewhere on the Internet. The term “display” as used herein shall mean the presentation of information in a format such as numerical, graphical or auditory. The term “network device” shall mean any device that can be connected to and communicate over a communication network. The term “financial accounting processes” shall mean a system used by an enterprise to generate at least one of a balance sheet, statement of earnings or other similar reports. The term “indicator” as used herein means a type of data, pertinent to performance of a business, which can be viewed according to at least one category. The term “category” as used herein means a grouping by which a user can view data corresponding to an indicator. A category may include multiple instances, such as the category “month” containing instances of January, February, . . . , December. Real world data defined by category(s) and indicator(s) combinations do not necessarily map directly to data in a database system. The term “parameter” as used herein means a single value or a matrix of values which is/are derived from an indicator and category combination. The term “value” as used herein means a numerical, textual, graphical or auditory representation of data or information. The term “drill-down” as used herein means an action causing presentation of data which typically provides underlying or additional detail to information currently being presented. A drill down, for example, may be performed on a parameter derived from a category(s) and indicator(s) combination by selecting a trend symbol pertinent to that parameter, causing data that pertains to the cause or effect of the trend to be presented. Data presented may be hierarchically related to the information currently being presented. For example, a drill down may be performed on a parameter derived from a category(s) and indicator(s) combination by selecting an instance of a category, whereby data of a category hierarchically related to the selected instance of the category is presented as it pertains to the indicator.

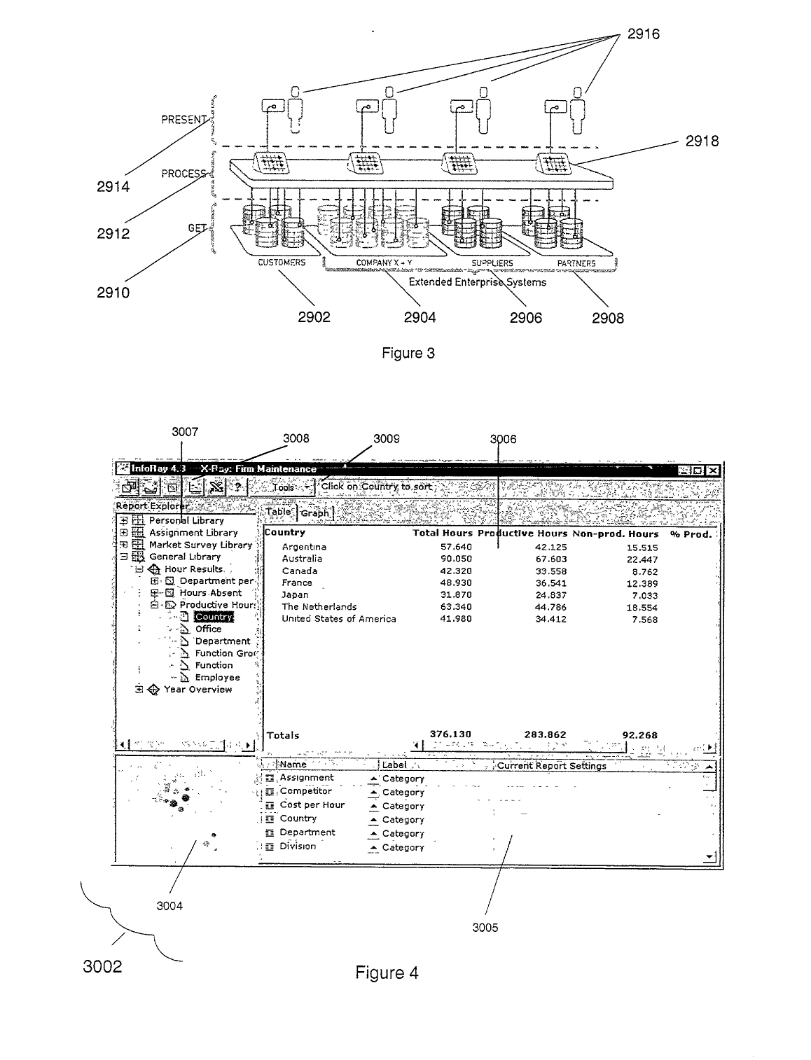

FIG. 3 shows a system for retrieving business data from at least one enterprise in accordance with one embodiment of the invention. In breaking from traditional get-process-present data systems, databases from multiple enterprises 2902, 2904, 2906, 2908 can be rapidly accessed and the data displayed in personal reports to a variety of end users 2916.

First, a business model is defined. The business model, which is created by an administrator, maps the data that can be requested by a user to the data contained in the databases 2914. The databases 2914 may be spread across multiple enterprises or corporations 2902, 2904, 2906, and 2908. Data is not moved to secondary systems, such as a data warehouse. Rather, information available in the course of operation of at least one enterprise is accessed directly at the source of data, and aggregated for short term use. In this manner, business data can be accessed in substantially real-time, supporting the needs of E-commerce. Additionally, since business data is accessed at the source, the various enterprises 2902, 2904, 2906, and 2908 do not lose exclusive rights to the data, as with a datawarehouse.

The data system utilizes the business model to map the business data requested by the user to the database. The proper data sources are then queried and the resulting data is retrieved and aggregated. In high-speed E-commerce, the system must respond quickly to the user, and therefore analytical processes, designed for analytical accuracy and completeness rather than speed, are not performed by the data system.

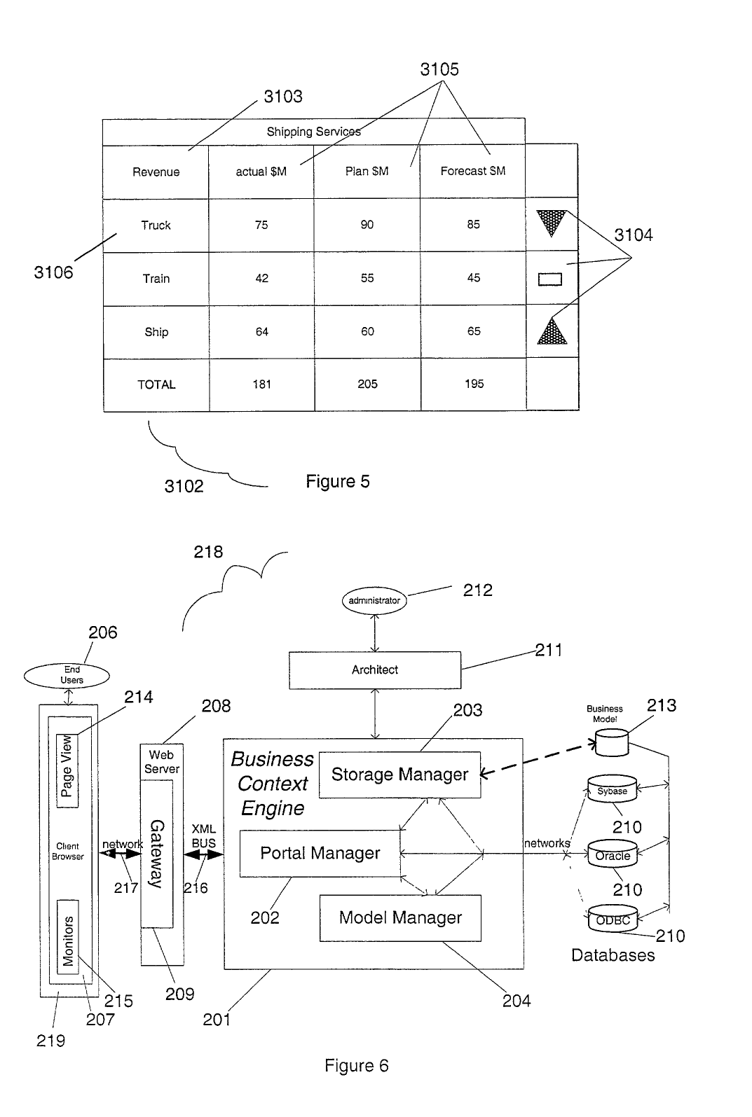

Once the data is retrieved, the data is presented 2914 to the requesting client user 2916. JavaScript templates are used providing personalized, interactive information to individual end users 2916 in either page view 3002, shown in FIG. 4, or a monitor 3102, shown in FIG. 5. Information is presented in an easy to read fashion that requires minimal end-user training and does not require the end-user to know the underlying datastructure of the databases nor the location of each database. For example, using standard browser technologies, users are able to view a high-level monitor 3102 and drill down to find details concerning trend changes of the information they are viewing. Because the monitors are built using templates, customers are able to rapidly customize their look and feel to suit their particular requirements. In this manner, only pertinent data is shown. Additionally, since monitors 3102 are easily customized, business data can be properly presented, in real-time, to all levels of client users, allowing them to quickly take action when problems arise. The monitors 3102 are constructed around trend markers 3104, which provide a graphical display of a trend in business data over time. By managing these trend markers 3104, client users can quickly avert problems before they affect the financial performance of a company.

In accordance with one embodiment of the invention, FIG. 6 shows a system 218 for quickly and automatically accessing information from databases 210 of multiple enterprises on a network 217, based on a request for that information by a client user 206 on a client browser 207. Business data from multiple databases 210 on a network can be viewed, combined, and processed according to different lines of user inquiry. The user inquiry for business data is linked to a business model of the database(s), whereupon requests are sent to each database to retrieve the data. The retrieved data is then sent back to the user in the desired format.

In various embodiments of the invention, the network 217 may include wireless and satellite communications, and is not limited to the Internet. Additionally, the client 219 may be a computer, mobile device, such as, a handheld personal digital assistant, a cellular phone, or a pager. The system 218 may be implemented, in part, as a computer program product having computer instructions for use with a computer system. Those skilled in the art should appreciate that such computer instructions can be written in a number of programming languages for use with many computer architectures or operating systems. Such languages include, but are not limited to, C and C++.

In FIG. 6, an end user 206 on a client browser 207 sends a query to a web server 208 over a network 217. A gateway 209, explained below in more detail, receives this request and forwards it to a business context engine. In response to the data request, the business context engine queries, transforms, and aggregates data from the various databases, operational stores or caching systems 210. The business context manager 201 then delivers a response back to the user 206 via the gateway 209.

The business context engine 201 consists of three different managers: a portal manager 202, a storage manager 203, and a model manager 204.

The portal manager 202 serves as the interface between the gateway 209 and the storage manager 203 and model manager 204. XML data requests sent by the gateway 209 are forwarded by the portal manager 202 to either the storage manager 203 or the model manager 204. Upon receiving the requested data back from a manager, the portal manager consolidates this information into XML messages, which are sent back to the gateway 209.

The model manager 203 manages the business model. The business model can be represented as a two dimensional graphical representation, where all the enterprise's individual business data resources are displayed as an intersecting set of “categories” and “indicators”, which shall be explained more thoroughly below. This business model maps the requested business data to the data that is stored in the various databases. By using the business model, the model manager 203 can receive XML requests for data from the portal manager 202, map the requested data to the database, and retrieve the requested business data by generating an appropriate command to the database, such as an SQL query. Retrieved data is sent back to the portal manager 202, whereupon the data is sent back thru the gateway and ultimately received by the client browser 207.

The storage manager 204 manages and temporarily stores the data compiled by the other managers in the business context manager 201. Additionally, the storage manager 204 stores administrative data, which includes, for example, the business model 213, reports, and end user rights for accessing data or a particular business model 213.

The client users 206 interface with the business context engine 201 via their client browser 207 using page view 214 or monitor 215 tools. FIG. 4 is an example of page view. Page view 214 allows the client user 206 on the client browser 207 to select indicators and categories contained in the business model, which are then forwarded to the business context engine 201. Based on the selected indicators and categories, the business context engine 201 derives parameters using the business data. These parameters are then forwarded to the client user 206 and displayed. Monitors 215 are another means by which the system displays information to the end user. An example of a monitor is shown in FIG. 5. In addition to showing business data associated with a predefined template, monitors 215 provide a set of simple, visually orientated, trend symbols 3104 (FIG. 5) which provide status of a particular indicator. By selecting a trend symbol 3104, the end user 206 will be provided detailed information related to the selected trend symbol. This detailed information may also have trend symbols which allow a user to visually narrow the reasons for trend changes of the originally selected trend symbol.

Administrators 212 control and manage the data system 218 through an architect tool 211. For example, using the architect's semantic modeling technique, the business model can be created.

The Business Context Engine 201 communicates with the Web Server 208 via the XML Bus 216. The XML Bus 216 uses channels as an abstraction layer that hides the physical location of the services. Thus, all connections are made between services and processes instead of actual machines. Messages in the XML bus 216 are communicated between processes via channels, with multiple processes able to send data to the same port at the same time. In addition, more than one process may receive messages from the same port simultaneously. In other words, the bus allows “many-to-many” relationships between sending and receiving processes such that multiple client users may engage in requesting data simultaneously.

The model manager 204, the architect 211, the gateway 208, and the end user interface, which includes page view 214 and the monitors 215, will now be examined in more detail.

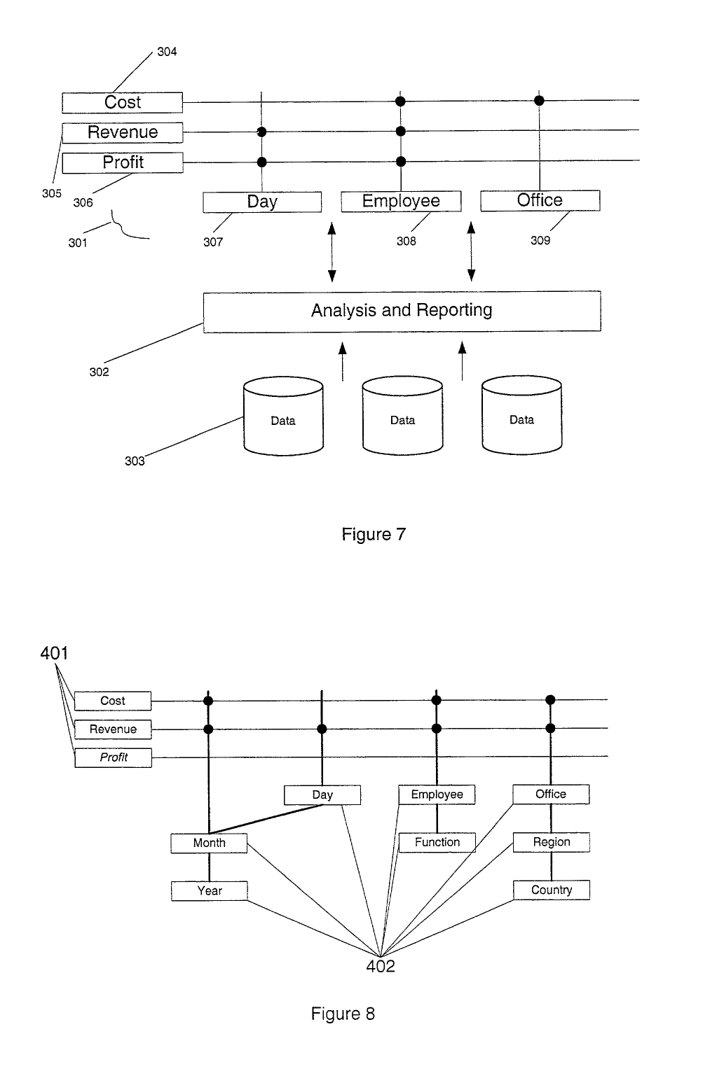

The model manager, through the creation and management of a business model, accesses the information contained in the various data sources. As shown in FIG. 7, the business model 301 serves as a link between the business data in the sources 303 and the analytical software 302. The information required for composing reports, such as monitors and page views, is extracted using the business model 301 by mapping the business data requested to the data sources 303.

The business model 301 is represented by a two-dimensional grid that consists of indicators, categories, and relationships. Types of data pertinent to performance of a business are called indicators, and may include, but are not limited to, numerical, textual, graphical, or auditory values. The business model must include at least one indicator Iᵢ (iεA, A={1, . . . , m, m a non-zero integer}). In FIG. 8, the indicators 401 are located on the left-hand side, or Y-axis, and include “cost”, “revenue”, and “profit”. Many indicators are directly retrieved from the information sources in which data is stored. Indicators may also be calculated; such indicators may be referred to as derived indicators. An example of a derived indicator is “profit” (profit=revenue−cost), where revenue and cost exist within one or more data sources but profit does not.

Indicators can be viewed in different groupings, called categories. The business model must include at least one category Cⱼ (jεB, B={1, . . . , n, n a non-zero integer}). In FIG. 8, the categories 402 are located on the bottom, or Y-axis and include “day”, “month”, “year”, “employee”, “function”, “office”, “region”, and “country”. Categories can be mutually related, where one category is a refinement or subset of another category. For example, the category “year” has a one to many relationship with the category “month”, in that each year consists of twelve months. A user looking at cost data using the “year” category can thus drill down by selecting cost data to be displayed by the category “month” for a given “year”. Other relationships between categories are shown, such as between “day” and “month”, “month” and “year”, “employee” and “function”, “office” and “region”, and “region” and “country”. Relationships can exist not only between categories, but also between indicators and categories, between multiple indicators, and between multiple categories. As a further example, the indicator, “cost”, may be a derived indicator, such that, it is composed of the sum of “variable costs” and “constant costs”. The indicator “cost” can then be displayed by various categories, which may be derived categories of the derived indicator “costs”. For example, the element “variable costs” of the derived indicator “costs” for a computer business may be displayed by the categories which form the variable costs, for example, “bonuses” for employees and “price of components” to manufacture the computers. The category “bonuses” may be a derived category such that a bonus for a particular employee may be calculated based upon the formulas “if revenue>target+10% then 10,000 bonus”, “if revenue>target+20% then 20,000 bonus” and “else no bonus” and then all bonuses are summed for each employee to provide the indicator, “variable cost” for the derived category of “bonus”. In such a fashion, complex relationships may be made within the business model. It should be understood that such categories and indicators are based on a concept which defines a business and are abstract from the underlying databases and business data until connections are made between the business data and the category-indicator business model.

The connection points on the intersections of the grid affirm the relationship between the indicator and category, and indicate which indicators 401 can be viewed for which categories 402, such as “revenue” per “country”. A connection point indicates that for a given indicator and category combination, {Iᵢ, Cⱼ} a parameter Pᵢⱼ, can be derived from the business data. In FIG. 8 for example, the “revenue” indicator can be viewed by the “day” category. Information may not be available for all possible combinations of indicators 401 and categories 402. This is represented by a lack of a connection point at the intersections between the categories and indicators on the grid. For example, cost per day can not be retrieved from the business model shown. The data may not be available in the data sources, or may be protected.

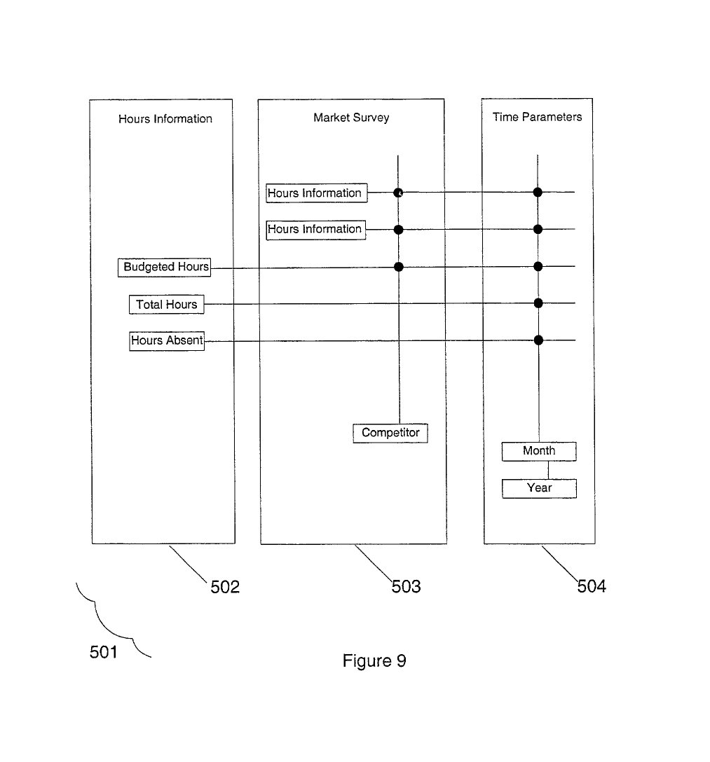

Indicators, categories, and the relationships between the categories and indicators define the business model. Using these elements for different segments of data contained within the one or more databases, various business models can be construed. In FIG. 9, three elements are shown that form a business model 501: hours information 502, market survey 503, and time parameters 504. These elements may be used to build additional business models, for example, a business model for the chief executive officer, a business model for the marketing department, or a business model for the sales staff. Business models built from the same elements are stored in a business model store 213 (see FIG. 6). A business model store 213 is a database or file that contains one or more business models.

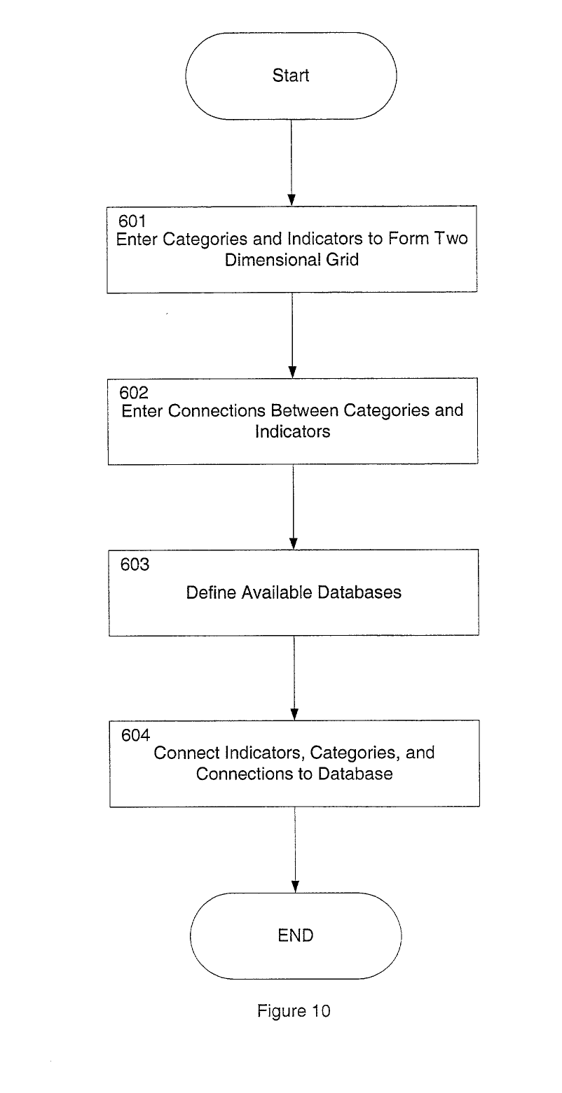

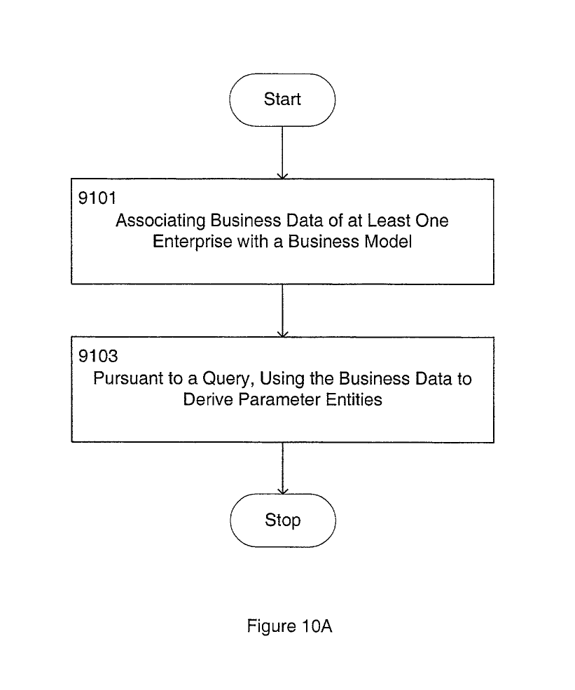

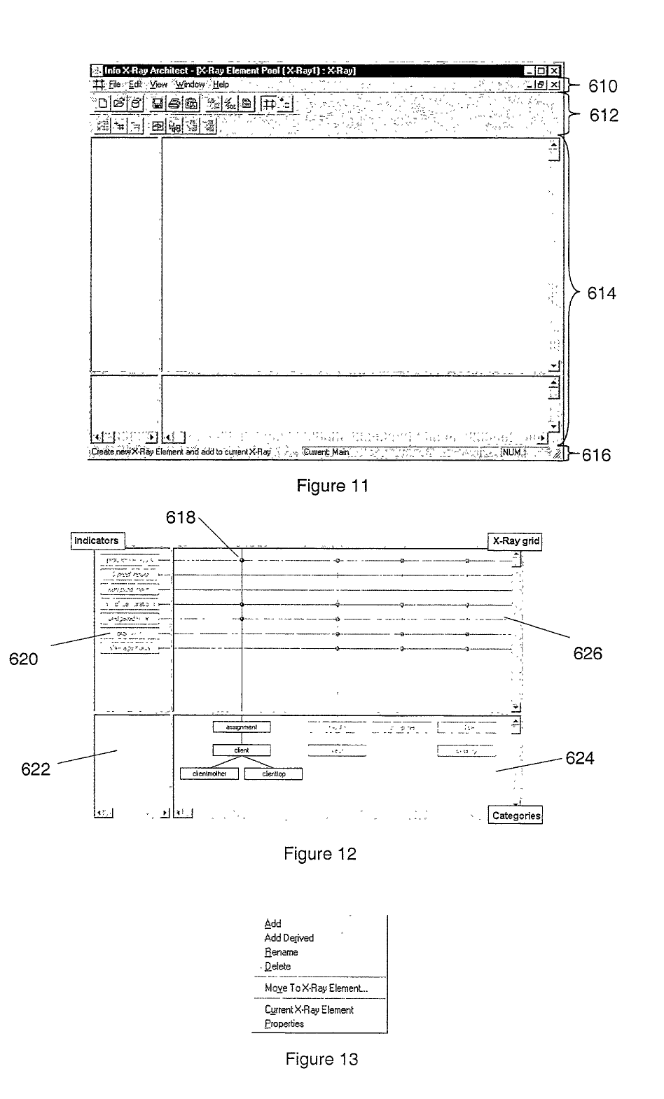

The business model is created and stored by administrators using an architect module 211 (see FIG. 6). In one embodiment of the invention, shown in FIG. 10, categories and indicators are first entered, step 601, to form a graphical representation consisting of a two dimensional grid. This may be accomplished by using displays similar to those shown in FIGS. 11, 12, and 13. FIG. 11 is a general display 618, containing a menu bar 610, a toolbar 612 and a status bar 16. Also within the display 618, are four panels 614, which can be used to contain the grid representing the business model, as detailed in FIG. 12. The bottom-left panel 622 is empty. The upper-left panel 620 contains the indicators, while the bottom-right panel 624 contains the categories. The two dimensional grid that connects the entered categories and indicators is represented in the upper-right panel 626. By selecting the upper-left panel 620, a menu is provided, FIG. 13, which allows the administrator to add or edit indicators. The menu also allows the administrator to specify derived indicators. Categories, and the relationships between categories, can be defined in a similar manner by selecting the bottom-right panel 614.

The connections between the categories and indicators are entered next, step 602. As described above, a grid appears in the upper-right panel 616 upon entering a category or indicator. To indicate a relationship between an indicator and a category, a connection point 618 can be added to an intersection point on the grid. In various embodiments, this can be done by selecting an intersection point and entering the desired connection. Three types of connections are utilized. Connected is the standard connection, and indicates that data pertaining to the indicator/category combination is available to the user. Not Active means that a standard connection is temporarily deactivated. Block Query designates a blocked connection that prevents specific users from obtaining data for the indicator/category combination.

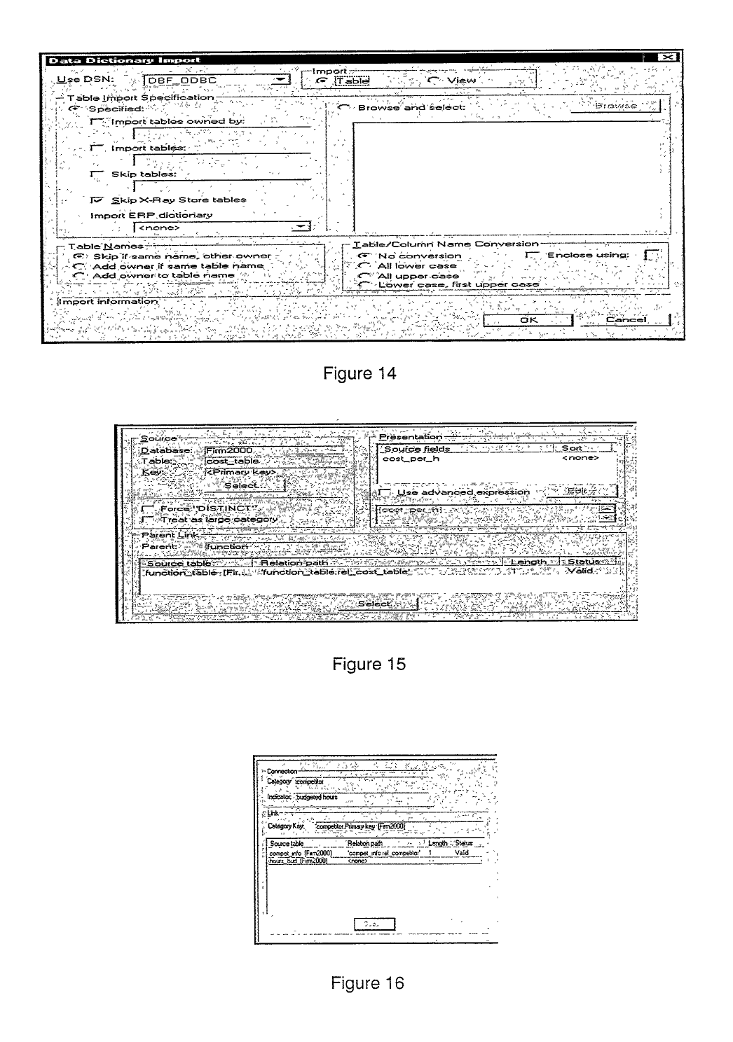

Next, the available databases are defined, step 603. One typical method used in linking with a database is to import the database definitions by retrieving the data dictionary of a database. When databases are not available during design of the business model, database definitions may also be entered manually. In this manner, a list of databases, along with available tables, fields, and keys is created. As an example, FIG. 14 is a graphical display for importing tables from a database. The administrator enters the Data Source Name (DSN), and selects Table in the Import group box. In the Table Import Specification group box, the Browse and Select option is selected. Upon selecting browse, the administrator can then select the tables to be imported.

The indicators, categories, and connections are then linked to tables, fields, and keys in the databases in step 604. FIGS. 15 and 16 are examples of a graphical display for linking a category and connections to the database, respectively. Connections that are linked to more than one table may be prioritized, such that the table with the highest priority is consulted first.

In this manner, business data of at least one enterprise is associated with a business model having at least one indicator, Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Ii may be pertinent as shown in FIG. 10A (Step 9101). For each pair of {Iᵢ, Cⱼ} there may exist a parameter Pᵢⱼ, derivable from the business data, represented by a connection on the two dimensional grid, that is susceptible to change over time. A parameter set S={. . . , Pᵢⱼ, . . . } can then be defined for all values of i and j for which a parameter Pᵢⱼ exists.

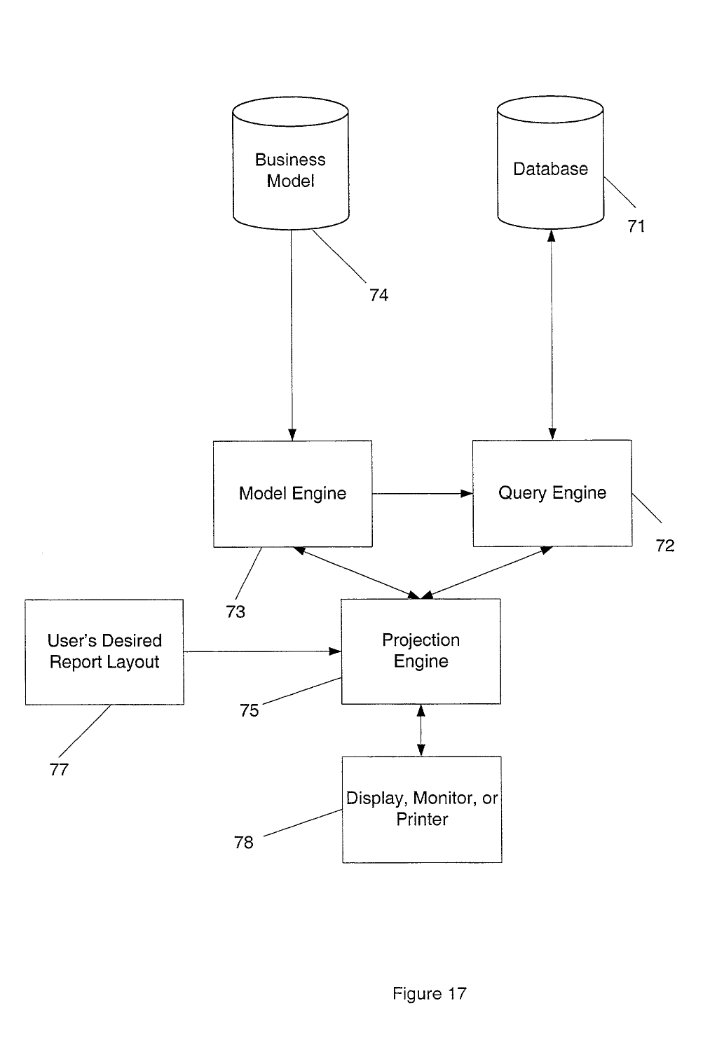

Once the business data of the at least one enterprise is associated with a business model, a computer process distinct from any financial accounting process retrieves data automatically based on a client user's data request for the presentation of one or more parameters. In one embodiment of the invention, three subengines, a model engine 73, a query engine 72, and a projection engine 75 are utilized to retrieve the data based on the user request, as shown in FIG. 17. In various embodiments of the invention, the model engine 73 and query engine 72 are components of the business context engine 201 (FIG. 6), while the projection engine is a component of the gateway 209 (FIG. 6).

The projection engine scans a desired report layout 77 containing the user request and forwards to the model engine 73 the desired information type in the report. The model engine 73 associates each desired information type within the report with a category Cⱼ (jεB, B={1, . . . , n, n a non-zero integer}) and indicator Iᵢ (iεA, A={1, . . . , m, m a non-zero integer}) pair for which a parameter Pᵢⱼ exists. This may be accomplished by a look-up table which has an associated thesaurus of commonly used terms such that a user's request is translated to terminology used within the business model. In this manner, for an indicator and category pair, a result subset {. . . , Pᵣₛ, . . . } rεA, sεB, of the parameter set S, is defined. Based on this result subset, and using the business model to associate parameter(s) Pᵣₛ to the database tables, fields, and entries, the model engine forwards a request for data specifying a specific field from a table in the database to the query engine 72. The query engine 72 then retrieves data from the database 71 by generating SQL commands, whereupon the business data is used to derive values Pᵣₛ (Step 9103) of FIG. 10A. In contrast to conventional systems, it is not necessary to preset commands, since these commands are generated in the query engine 72 on the basis of the model 74 and requests from the user 77 using indicators and categories, via the model engine 73.

Once the query engine derives the parameters Prs, the derived parameters are forwarded to the projection engine 75. The projection engine 75 then sends the derived parameters in the layout of the report, to computers, monitors, printers, or other display sources of the user.

Alternatively, in another embodiment of the invention, the model engine can associate desired information in a query with multiple category and indicator combinations, in addition to a category and indicator pair. For each value combination of categories and indicators V=V_{I}∪ V_{C}, where V_{I}={. . . , I_{α}, . . . } where αεA and V_{C}={. . . , C_{β}, . . . } where, βεB, there may exist a parameter P_{V} derivable from the business data, that is susceptible to change over time. A parameter set S={. . . , P_{V}, . . . } can then be defined for all V for which a parameter P_{V} exists. Pursuant to the query, a result subset {. . . , P_{W}, . . . } of the parameter set S is defined, where W is an element of the set of all V's for which a parameter P_{V} exists. The business data is then used to derive parameter values P_{W} For example, based on a query, desired information may be associated with two categories, “month” and “employee”, and the indicator “cost”. The parameter value P_{W} derived from the business data would then contain values for cost as it pertains to each month, with each month's cost value broken down by employee.

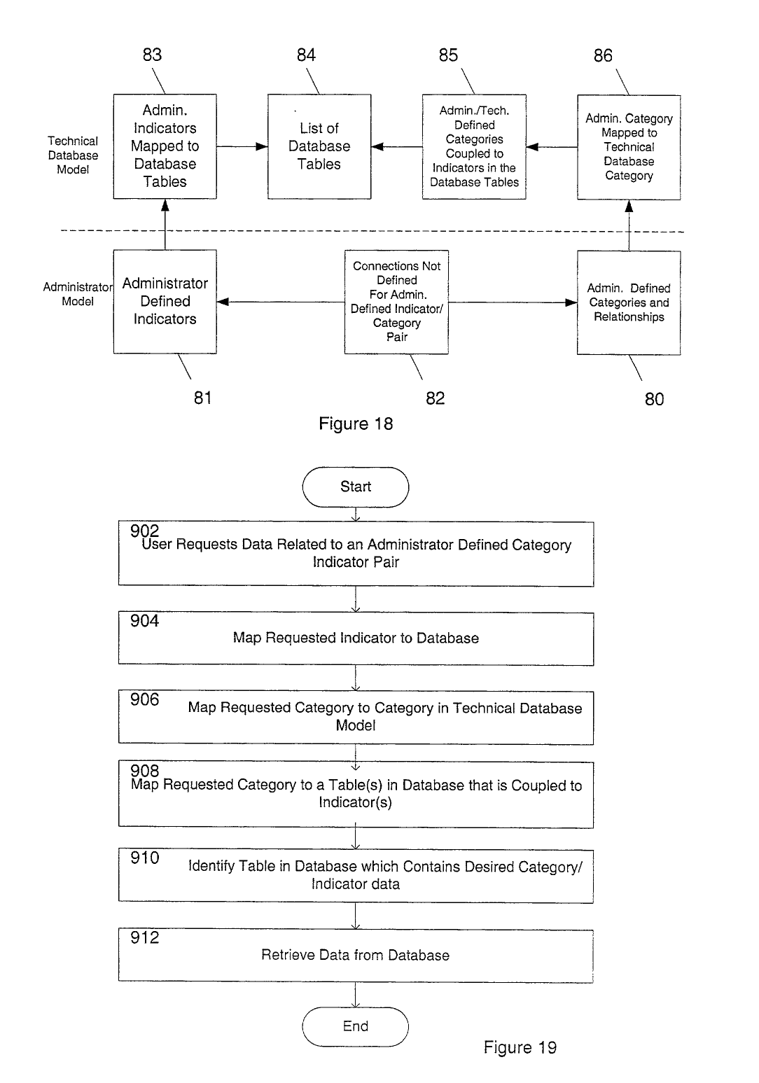

FIG. 18 shows how the business model is implemented by the model manager in accordance with one embodiment of the invention. In this embodiment, the business model comprises a user model and a technical database model. The administrator defined categories, indicators, and connections are part of the user model. On the other hand, the technical database model includes the categories, indicators, and connections that represent the underlying content and structure of the database(s). Each technical database category has a complete definition of all instances along with a link to the underlying database structure. Additionally, the location of each technical database indicator and category in the database is defined. Thus, the user model maps to the technical database model, which further maps to the underlying database.

Blocks 80 and 81 contain the indicators and categories as defined by the administrator, respectively. Additionally, block 81 maps the administrator defined categories to the categories in the technical database model, and defines the relationship between categories. Block 82 identifies which indicators are not connected to any category in the database. Data for such indicator/category combinations are not available in the database. For example, in FIG. 7, the indicator cost is not available for category day, and therefore the lack of this combination would be indicated in block 82. In general, the combination of blocks 80, 81, and 82 correlate to how the administer envisions the data, so as to allow the user to formulate a data request.

In contrast, blocks 83 to 86 represent the technical database model, and comprise of tables that are used to map the user model to the categories, indicators, and connections found in database. Block 83 provides the database location of each indicator defined by the administrator in block 80, including the database, the table, and the column. Some indicators may be located in more than one location in the database, and hence are listed multiple times. Block 86, connected to block 81, describes where each technical database category is defined in the database, so that information such as keys and category instance names can be derived. Block 85 then couples the categories, now defined by both the user and technical model, to the indicators. This is done by providing the location of where the categories can be found in the database in relation to the indicators. As with the indicators, some categories may be located in more than one table in the database, and therefore are listed multiple times. Lastly, a list of the database tables that contain data pertaining to indicator/category connections is found in block 84. This table is referenced by blocks 83 and 85, when providing the location of the categories and indicators.

FIG. 19 is a flowchart whereby the model manager, using the blocks described above, automatically retrieves data requested by the user in accordance with one embodiment of the invention. First, the user requests data that relates to a connection associated with an administrator defined category and indicator using a monitor or a page view, step 902. The requested indicator is then mapped to the appropriate database table, step 904, correlating to block 83 in FIG. 18. Similarly, the requested category is mapped to it's corresponding category as defined in the technical database model, so that key and instance names can be retrieved, step 906, and also mapped to a table(s) in the database that is coupled to the indicator(s), step 908, correlating to blocks 86 and 85, respectively. In various embodiments of the invention, the order of the steps 904, 906, and 908 is not important and can vary. Once the tables that contain either the requested indicator or category are determined, the table containing both the administrator defined category and the indicator is identified, step 910. This table is forwarded to the query engine, along with the appropriate column and item name information, so that data can be retrieved by the query engine, step 912.

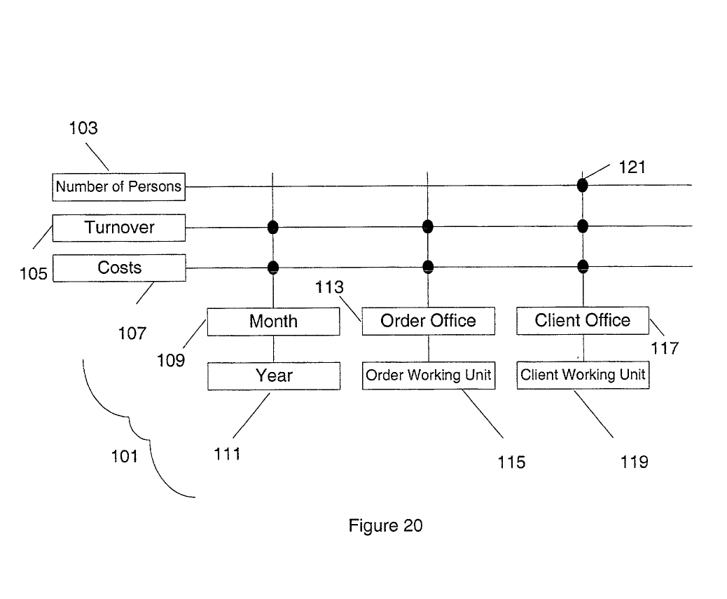

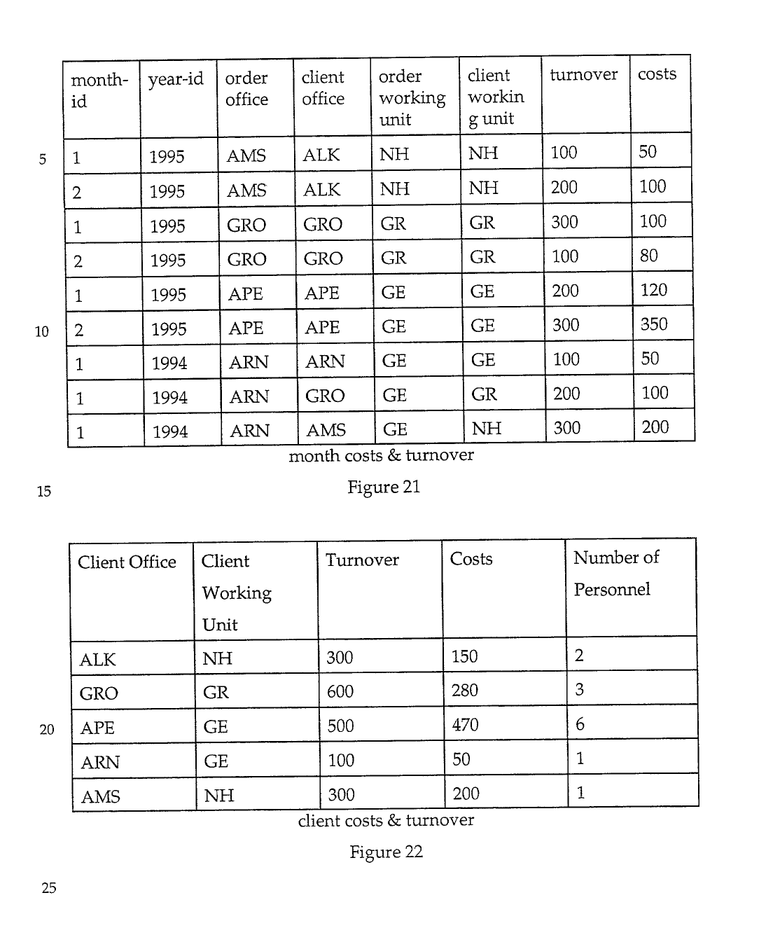

As an example, FIG. 20 is a business model 101 as defined by an administrator, in accordance with one embodiment of the invention. For simplicity, the example is implemented with a single database having five tables, FIGS. 21-25, although this methodology is equally applicable to multiple databases and multiple databases in multiple enterprises. Additionally, FIGS. 26-32 represent the tables formed in implementing the relationships created by the model manager. Based on a desired report layout, such as the one shown in FIG. 3, the model manager maps the requested data to the database, and forwards the database location of the requested data to the query engine.

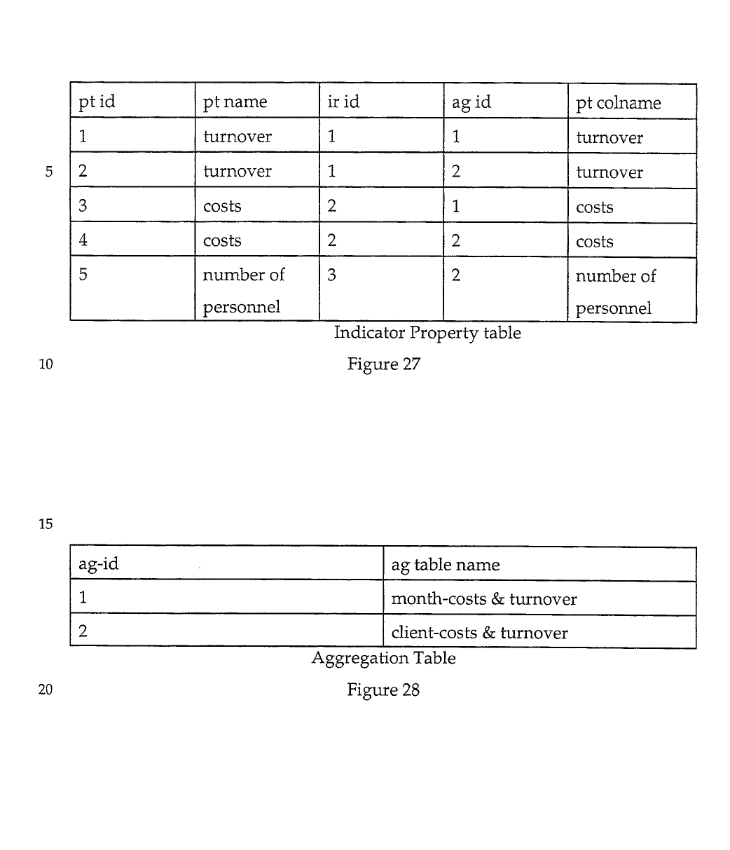

FIG. 26, which corresponds to block 81 of FIG. 18, identifies the indicators defined by the administrator which are available to a user. These indicators are shown on the left hand side of the business model of FIG. 20, and include “number of personnel” 103, “turnover” 105, and “costs” 107. FIG. 27, corresponding to block 83 of FIG. 18, describes the properties of the indicators, including the location of the indicator in the database by table number and column name. Indicators “turnover” 105 and “costs” 107 are found in two tables of the database, and therefore each of these indicators are listed twice. Hence, the system allows an administrator to define a concept, where an indicator representative of the concept is mapped to multiple locations in the database.

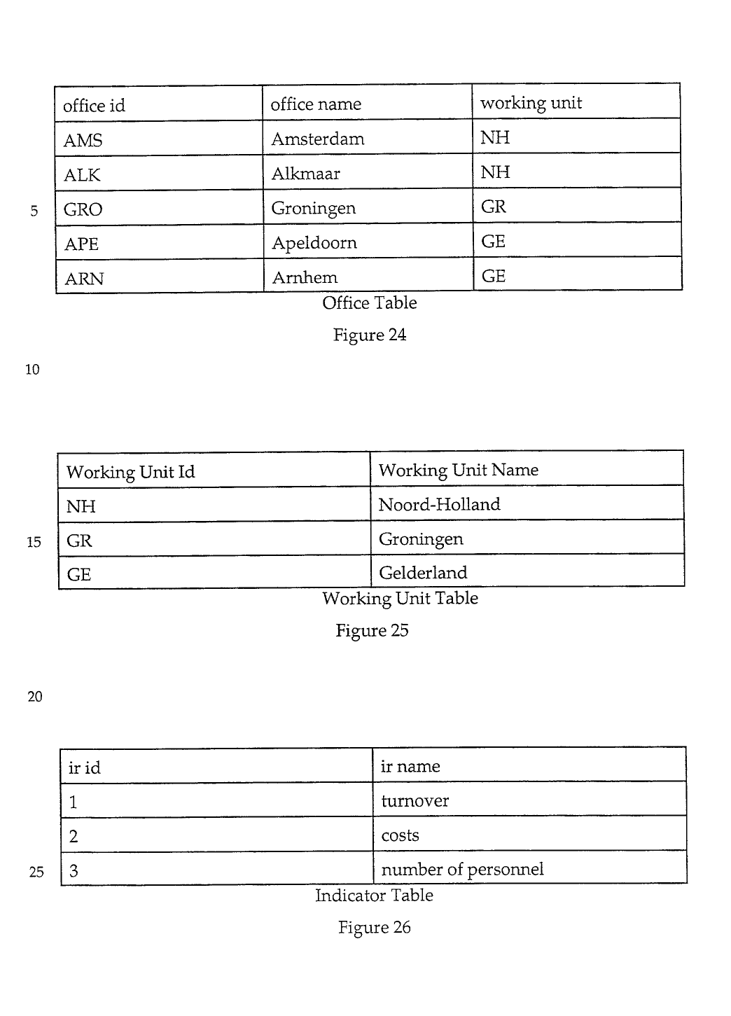

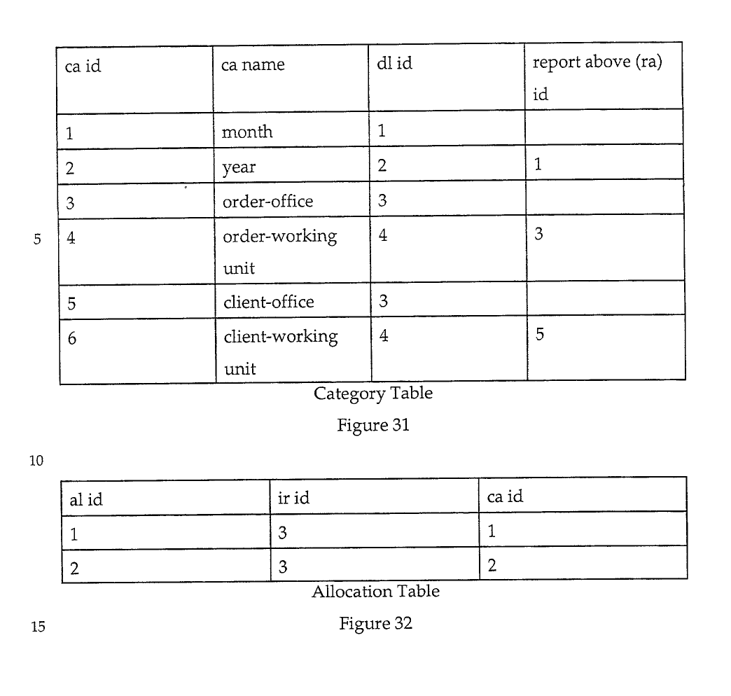

The categories defined by the administrator, shown on the bottom of the business model in FIG. 20, are identified in FIG. 31, which corresponds to block 80 of FIG. 18. In contrast to the indicators being mapped to more than one location in the database, the six categories 109, 111, 113, 115, 117, and 119, defined by the administrator map to only four categories in the database that have instance identifiers (database category ids 1-4). For example, the administrator has defined two categories, order office 113 and client office 117. However, only one table (FIG. 24) in the database relates instances pertaining to the category office to the database. The administrator defined categories ordering office 113 and client office 117 are therefore equal to each other at the level of the database, each being mapped to the database category office. Thus, in addition to unifying multiple database data into administrative concepts, the reverse is true, multiple administrative concepts can be unified with business data.

The user can drill up or down on an instance of a category by opening a category that either reports above or below it, respectively. For example, the user may view data under the category “year”. By selecting a particular instance of the category “year”, and the category “month”, the user can then view data by “month” within each “year”, which reports above to “month”. In FIG. 30, categories “year”, “ordering-working unit”, and “client working-unit” report above to categories “month”, “order-office”, and “client office”, respectively. Each of these relationships can be categorized as being one to many. For example, order-working unit Gelderland has two order-offices, Apeldoorn and Arnhem.

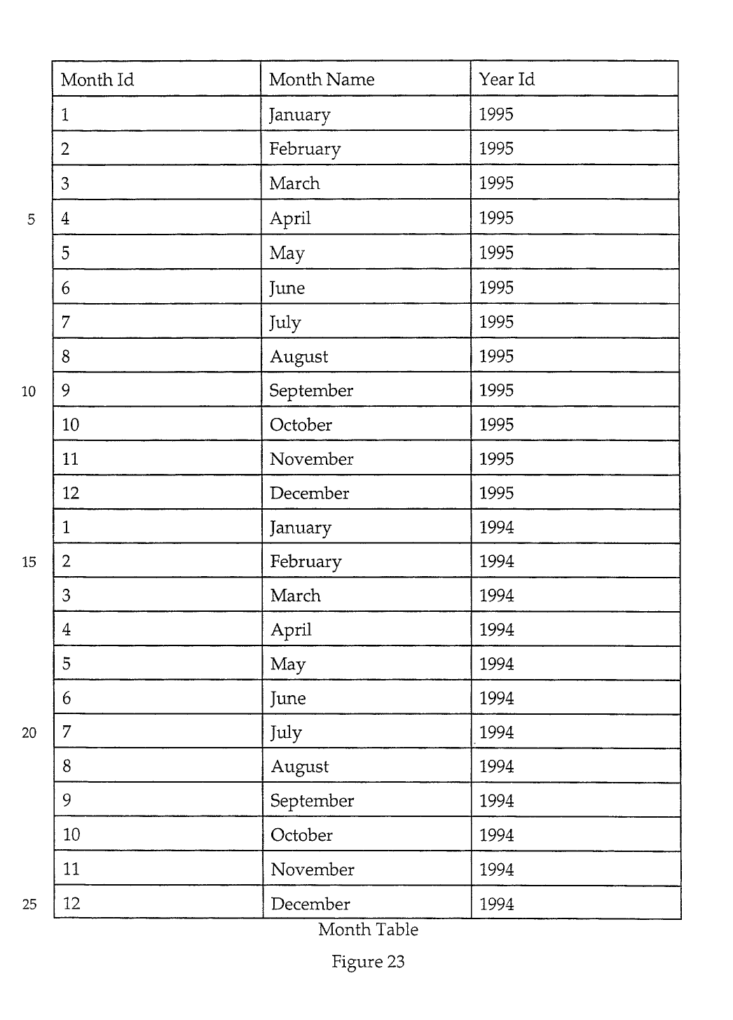

FIG. 30, corresponding to block 86, provides the name of a table and corresponding column name for each of the four categories in the database, wherein instance names and keys for each category are defined. For example, if the user requests information for the month of January, the category “month” is first looked up in FIG. 31, which provides a dl id of 1. Using dl id 1 in FIG. 30, the dl-table named “month-table” is identified, along with column name id “month id” and dl-colname-name “month name”. The model manager accesses the “month-table” table in the database of FIG. 23, and looks up “January” under the month-name column, and finds under the “month id” column that the number 1 represents January in the database.

Corresponding to block 84, FIG. 28 lists the tables in the database which contain data associated with both an indicator and category. Only two tables are shown in this example, the month-costs & turnover table, and the client-costs & turnover table, having corresponding table identifiers of 1 and 2, respectively. These tables may be used in the following manner. Indicator “turnover” in FIG. 27, has a table identifier of both 1 and 2, and thus can be found in both tables, while the indicator “number of personnel” has a table identifier of 2 and can only be found in the client-costs & turnover table.

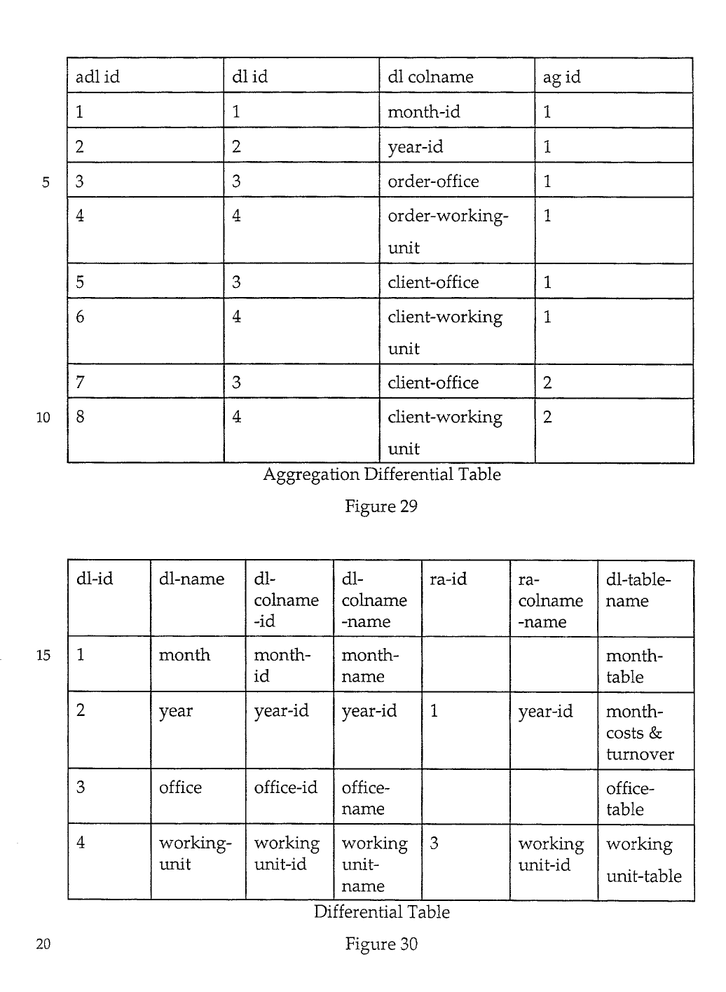

FIG. 29, corresponding to block 85, lists the administrator defined categories, which are associated to a technical database category, and the location of where the categories, coupled to indicators, can be found in the database by referencing the appropriate table id. Certain user categories appear more than once in the database, and thus are listed more than once in FIG. 29. For example, both client-office and client working unit can be found in tables 1 and 2. Additionally, FIG. 29 lists the appropriate database category id, so that category instances can be cross-referenced to their identifiers in the database using FIG. 30 (see above).

When data pertaining to an indicator-category combination is requested, the common table id of the given indicator and category is determined, using FIGS. 27 and 29. Data can then be retrieved from the table corresponding to the common table id and processed if necessary.

Queries formulated by a user give more extensive results than is usually the case in conventional systems. According to one embodiment of the present invention, a so-called non-available can be generated for selected items within a category where no indicator data is available, such that the system does not malfunction. This can be illustrated in FIG. 21, where for months other than January and February no turnover data is available. Data for January and February is retrieved and for missing months a non-available symbol is provided. The final results are produced on the basis of the months defined in FIG. 23 rather than on the basis of available months in FIG. 21.

In another embodiment of the invention, derived indicators or categories are defined by an administrator and associated with a formula. Upon a user query, the value of the derived indicator or category is calculated by the model manager using the associated formula. Hence, the derived indicator is not stored in the database(s). An example of a derived indicator is profit, which is indicated using italics in FIG. 7, and which is associated with the formula profit=revenue−costs. The model manager, using the associated formula, retrieves the required data pertaining to indicators revenue and cost from the database(s) to derive profit. Profit is not stored in the database, but calculated based upon a user query.

Next, an example illustrating how FIGS. 19-32 are used to gather information is presented, according to one embodiment of the invention. A user requests, in step 902 (FIG. 19), information pertaining to indicator “number of personnel” and category “client working unit”, as defined by the administrator. This information is represented by connector 121 shown in the two dimensional business model of FIG. 20.

The indicator “number of personnel” is first mapped to the database, step 904. Using FIG. 26, the indicator name “number of personnel” correlates to indicator identifier 3. This indicator identifier is utilized in FIG. 27, to determine that the indicator “number of personnel” can be found in one table in the database, represented by ag id no. 2. Using FIG. 28, ag id no. 2 correlates to the client-costs & turnover table, shown in FIG. 22.

Next, the requested category is mapped to it's corresponding category in the technical database, step 906. Using FIG. 31, requested category “client-working unit” (category identifier 6) has a technical database category dl-id of 4. By going across the row pertaining to dl-id 4 in FIG. 30, it can be found that the “client-working unit” corresponds to the category “working unit” in the technical database. Furthermore, instance names for the category “working unit” may be found in the “working unit-table”, which corresponds to FIG. 25—NH corresponds to Noord-Holland, GR corresponds to Groningen, and GE corresponds to Gelderland . Note that FIG. 31 also describes category client-working unit as reporting above to category client office, having technical database category dl-id of 3. Using FIG. 30, dl-id 3 corresponds technical database category “office” and refers to dl-table-name “office table”, wherein the relationships between offices and working offices can be found.

The requested category is then mapped to tables in the database that are coupled to indicators, step 908. Using FIG. 29, the category client working unit is found in two tables of the database, with table ids of 1 and 2. In FIG. 28, these tables are defined as the month-costs & turnover table, FIG. 21, and the client-costs & turnover table, FIG. 22, respectively.

The table in the database which contains the desired indicator and category information can then be identified, step 910. In the subject example, it has been determined that the indicator “number of personnel” is found in the client-costs & turnover table, FIG. 22, and that the category “client working unit” is located in both the month-costs & turnover table, FIG. 21, and client-costs & turnover table, FIG. 22. Hence, the table which contains both the indicator and category is the client-costs & turnover table, as shown in FIG. 22. In alternative embodiments, this table may also prioritize the connections between indicators and categories, as discussed above.

The data is then retrieved from the database 912 using the client-costs & turnover table, FIG. 22. The names of the columns utilized , “number of personnel” and “client-working unit”, are obtained from FIG. 27 and FIG. 29, respectively. Note that this example may be implemented with derived indicators and categories such that the derived indicators and categories which are not found within any of the data sources are derived by the model manager subsequent to the retrieval of business data that is required for the derivation.

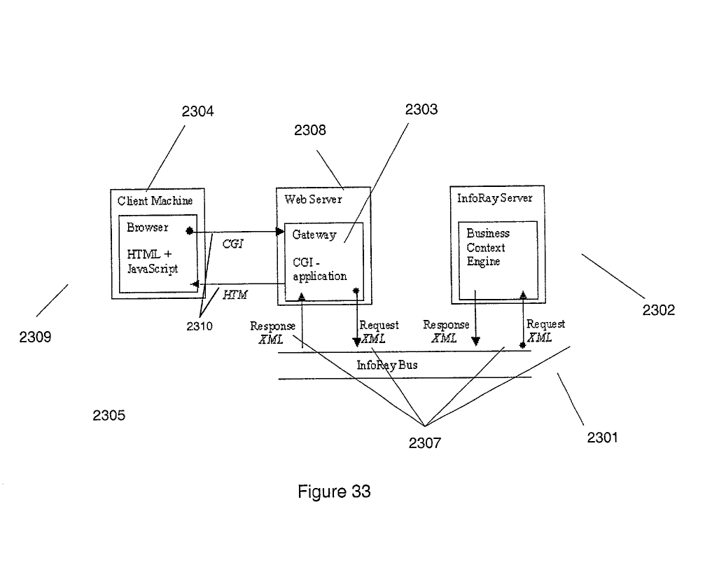

FIG. 33 shows a system which allows end users on a client machine 2304 to access and retrieve data through the business context engine 2302 in accordance with one embodiment of the invention. The client machine communicates with the business context engine via a network 2310, which may include mobile and satellite communications, and is not limited to the Internet. Additionally, the client 219 may be a computer, mobile device, such as, a handheld personal digital assistant, a cellular phone, or a pager.

A client user at a client machine 2304 which is coupled to a network 2310 and in communication with a remote server 2308 makes a request for presentation of a business concept in the form of indicators and categories forming one or more parameters. This communication may be initiated at the browser 2309 of the client 2304 by using either a hyperlink or form. In one embodiment of the invention, the request is in the form of a CGI request for execution of script at the server. In this request of a business concept, the user may need to access one of a multitude of databases. Accompanying this CGI request are identifiers which are representative of data which resides in the databases. This representative data may be category and indicator combinations or direct calls to the underlying database structure.

After receiving the CGI request, the server 2303 accesses the CGI bin and interprets the requested script. The script communicates with a secondary processor 2302. In various embodiments of the invention, the secondary processor 2302 is the business context engine 2302, or alternatively, the same processor utilized by the server 2308. The identifiers are used to retrieve business data which is used to derive parameters Pᵣₛ. After deriving the parameters Pᵣₛ, the secondary computer 2302 forwards the parameters Pᵣₛ back to the server 2308. Such communication, in various embodiments of the invention, is conducted via an XML bus 2301 using XML request and response messages 2307.

The requested parameters are now available at the server. To support multiple users, a webserver application is designed such that HTML rendering of the requested data is not performed at the web server 2308, but in the client process which is running on the client user's machine. In this manner, the burden of rendering the data at the server 2308, which typically is processor intensive and subject to scalability problems, is removed and distributed to client machines.

In one embodiment of the invention, the web server 2308 application utilizes HTML templates. These HTML templates include an HTML body wrapper. Such body wrappers do not provide rendering information but only information so that the HTML is recognized by an HTML enabled browser. The JavaScript within the HTML wrapper creates a graphical presentation of the parameters. To overcome the native inability of JavaScript for data acquisition, a keyword is inserted into the template. The server 2308 replaces this keyword with JavaScript variables that are generated using parameters Pᵣₛ as received from the secondary computer. Note that the server application does not generate any HTML, nor in this embodiment does it replace any other strings other than the keyword(s).

Once the JavaScript variables containing the requested data are pasted into the template, the template is sent to the client browser. The JavaScript within the template is then executed at the browser at load time to create HTML code, whereupon a display is generated at the client. Thus, client side rendering of the parameters derived from remote data sources is realized by using JavaScript.

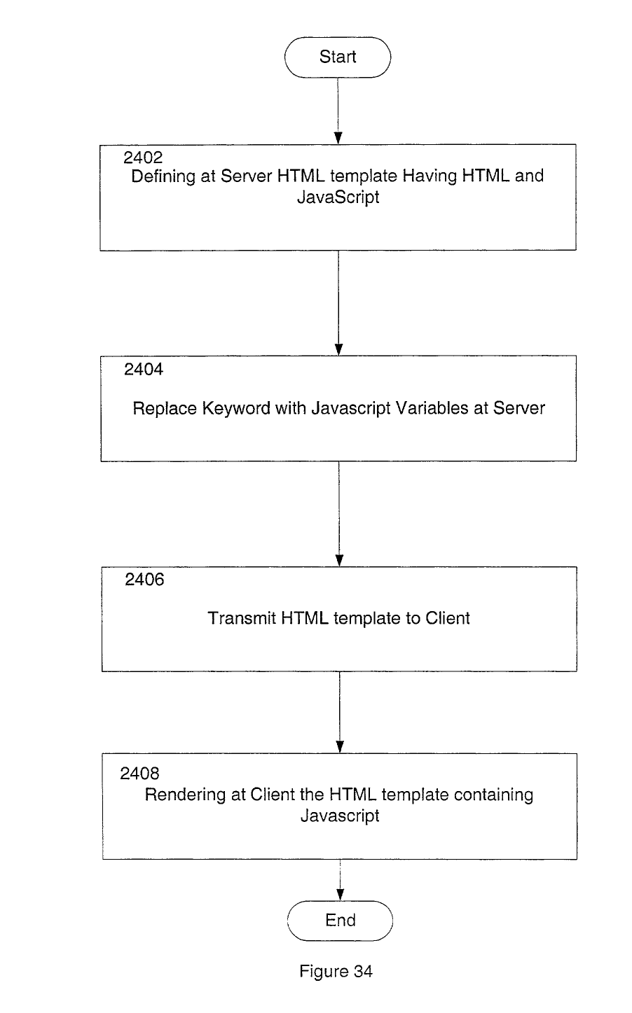

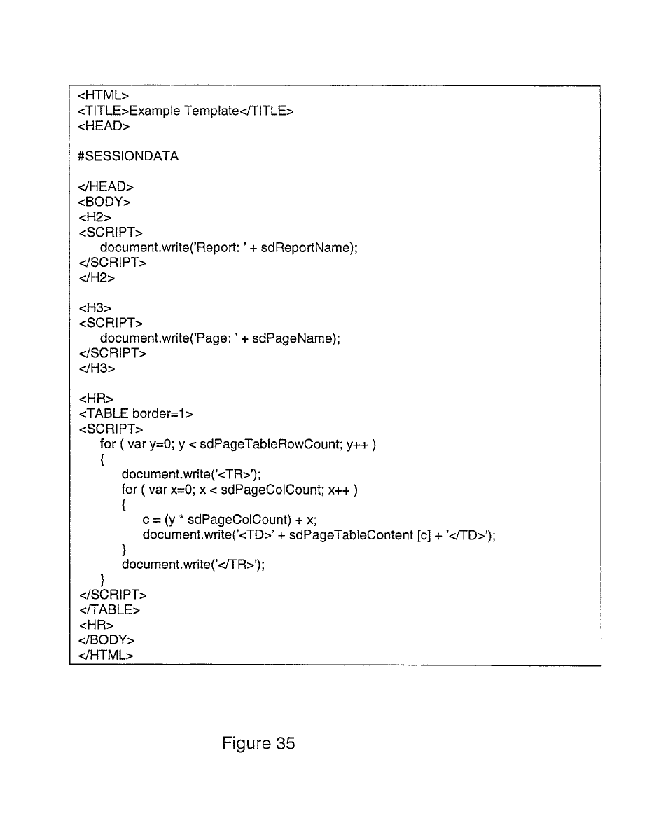

FIG. 34 is a flowchart illustrating the above method for rendering data using JavaScript in accordance with one embodiment of the invention. An HTML template is defined 2402 at the server, which includes an HTML body wrapper and JavaScript. Included in this template is a keyword that is utilized to support the data acquisition. FIG. 35 is a sample template, 2501 containing the keyword #SESSIONDATA. The JavaScript in the template 2501 references the JavaScript variables to be merged into it.

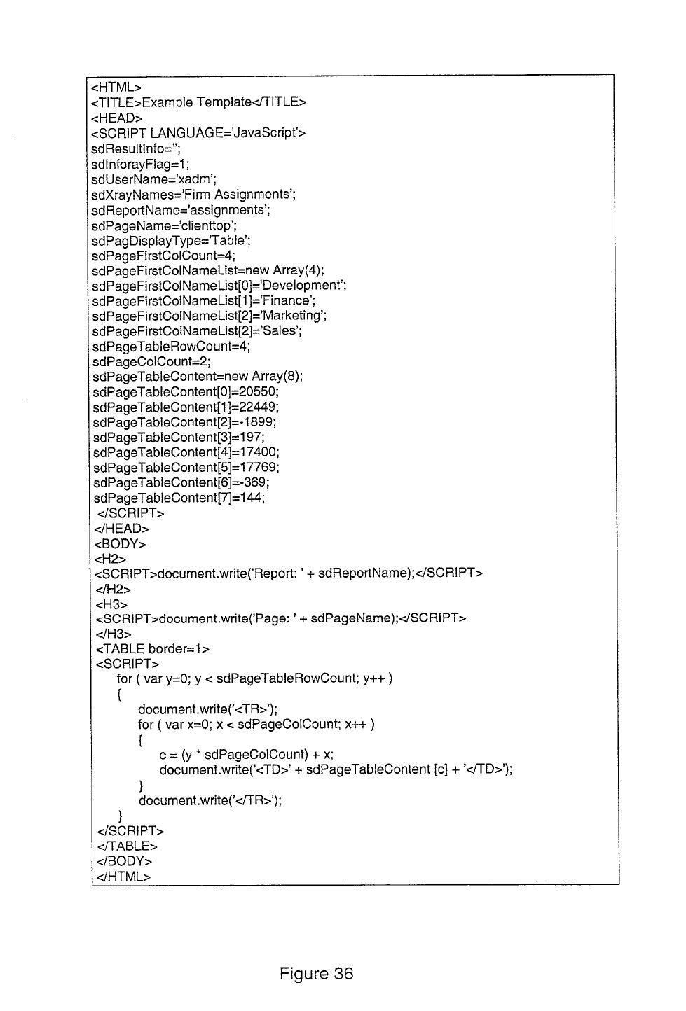

Next, the server replaces the keyword with the JavaScript variables, step 2404 in FIG. 34. These JavaScript variables are requested and received, in various embodiments of the invention, from the business context engine via the XML bus. FIG. 36 is an HTML file showing the result of merging the sample template in FIG. 35 with the session data for a simple table. The table in this example contains two columns, both with four rows.

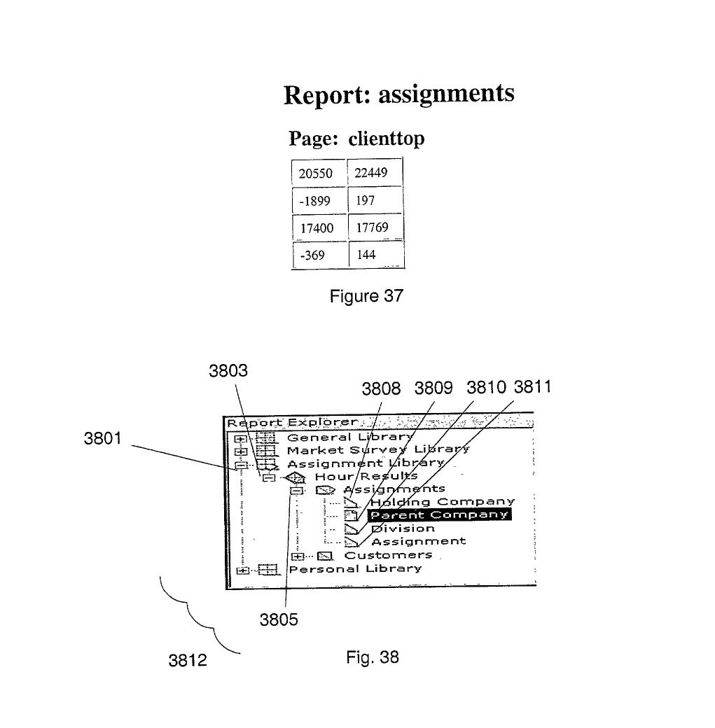

The complete HTML template, now containing an HTML body wrapper, JavaScript, and the JavaScript variables, is then transmitted to the client, step 2406 of FIG. 34. Once received by the client, the JavaScript is interpreted at load-time and rendered on the screen, step 2408. For example, the HTML file in FIG. 36 will be interpreted by the client browser at load time to render the table in FIG. 37.

As discussed previously, end users interface with the business context engine using a page view or monitor display. By using these displays, business concepts resulting in parameters Pᵣₛ can be requested. Parameters Pᵣₛ may be presented as, but are not limited to, textual content, graphical content, numerical content, or auditory signals. Additionally, the parameters Pᵣₛ may be directly retrieved from the various sources, or may be resultant data calculated from raw data in the various sources. Raw data is the most rudimentary data kept in the data sources such that no data exists on which the raw data can be calculated. For example, raw data is total dollar amount for a given month, assuming that there is no total dollar amount for a shorter time period such as day, hour, or minute. Resultant data is total dollar amount for a given year, since it is derived by summing the total amount for a month over a twelve month period.

In various embodiments of the invention, a client user utilizing a browser connects to a server over a network, such as the Internet. The user requests a business model by sending a signal to the web server. This may occur through a login procedure in which a user identification is associated with a particular business model. In various embodiments of the invention, the requested business model is associated with a predefined template for displaying personalized data, or, alternatively, a list of templates associated with the business model may be presented to the user so that a particular template can be selected.

As discussed in more detail above, in an embodiment of the invention, the template is a web page which is dynamically constructed based upon a request from a client. The template associated with the business model is stored at the server and consists of an HTML body wrapper, containing JavaScript code and a keyword. The server acquires the user requested data needed to complete the template from the secondary computer. By utilizing the business model, which maps the requested categories, indicators, and connections to the database(s), the secondary computer gathers the requested data, and, if necessary, performs various operations on the retrieved data, before sending it back to the server. At the server, the keyword is then replaced with JavaScript variables that represent the retrieved data. Once the template is complete, it is sent to the client browser, where it is rendered in real time.

The parameters Pᵣₛ displayed at the client browser may be associated with other business data contained in the multiple databases. In various embodiments, these associations are organized into a hierarchy of levels, which may have a cause and effect relationship with one another. Raw data may be contained at the lowest level, followed by resultant data which results from the raw data at the next higher level, with subsequent levels relying on previous resultant data. In various embodiments of the invention, the template rendered at the client includes an arrangement for controlling the display of parameters Pᵣₛ, such that associated business data in the database can be selected and displayed. Thus, a user viewing a level of data can graphically select a different level of data, whereupon a new template is displayed at the client browser.

In various embodiments, the template allows for drilling down of hierarchical data. By drilling down on high level data, lower level data is displayed showing a specific instance of the high level data. For example, assume a lower level category, month, has a one to many relationship with a higher level category, year, and that cost data for the category year is displayed. The category year has instances of 1998, 1999, and 2000. By selecting and drilling down on year 1999, cost data for the next lower level category, month, is displayed. However, rather than displaying for each month the summation of costs over all three years, only costs pertaining to the year 1999 are displayed.

In another embodiment of the invention, the template displayed at the client browser may contain graphical trend symbols that indicate the status of a parameter(s) Pᵣₛ presented in the display. By selecting a trend symbol, drill down occurs and data associated with parameter(s) Pᵣₛ is displayed to the user in a new template. A user can thus gain insight into why a parameter(s) Pᵣₛ has or has not changed. Note that the associated data displayed is not necessarily related in a hierarchical manner to Pᵣₛ, but may simply be associated with the trend. For example, if a trend symbol indicates that, for a given Pᵣₛ, the cost of bananas is rising, the associated data may pertain to a climate change in Costa Rica for example.

In accordance with one embodiment of the invention, FIG. 4 shows a typical display 3002 using page view. In utilizing page view, a user on a client browser requests a business model. The user is then presented with selectable categories and indicators associated with the business model. Upon selecting a category/indicator combination, data is retrieved from the multiple databases using the business model and eventually rendered at the client browser. The user may select the graphical representation for displaying the information content, such as numeric representation or various charts and graphs.

The display 3002 is composed of four panels 3004, 3005, 3006, and 3007, a browser toolbar 3008, and a message bar 3009. The size of each of the panels can be modified according to user needs.

The message bar 3009 displays the status of the current function being performed in page view. Additionally, descriptions pertaining to highlighted objects are displayed here.

The browser toolbar 3008 allows the user to select various functions that are typically performed by a browser and which are well known in the art. These may include, but are not limited to: back and forward buttons that allow a user to move backwards or forwards through page view, thus a user may undo certain actions recently performed by using the back button; a print button; a save button; and a home button, which takes the browser out of page view.

The report explorer panel 3007, located at the top left panel of the page view display, is utilized to control the display of information content. FIG. 38 shows an enlarged view of the report explorer panel 3007. Various objects are displayed in a hierarchical tree structure. By clicking on the expand icon next to an object, or the hyperlinked object itself, the underlying level of that object is expanded and/or opened. Four different types of objects may be displayed. These are libraries 3801, collections 3803, reports 3805, and pages 3807.

Libraries 3801 and collections 3803 are only used to group reports 3805 into directory structures. As such, libraries 3801 and collections 3803 can be expanded or collapsed, but not opened. Libraries 3801 and collections 3803 are typically defined by subject and/or owner and authorization.

Within a library 3801, collections 3803 are made up of one or more reports 3805. Each report 3805 is associated with a set of administrator defined categories and indicators, which a user may select from to form a page. A report 3805 may contain a plurality of pages 3807. When a report 3805 is selected by a user, the report's 3805 underlying pages 3807 are displayed. Additionally, the name of the report 3805, and the reports's available categories and indicators appear in the report panel 3005 (FIG. 4), which shall be discussed below in more detail.

A page 3807 is a partial collection of the categories and indicators that belong to the report 3805. When a page 3807 is selected by the user, the data corresponding to the page's associated categories and indicators is retrieved from the database via the business context engine and displayed in the results panel 3007 (FIG. 4) as a table or graph, and may include auditory signals. Each page 3807 offers the option of viewing the data in the report 3805 from another perspective or category. While each category in the report 3805 can be used as a page 3807, this is not always done, as not every combination of category and indicator produces information that is useful to the end user. Additionally, if the indicator/category combination is not included in the business model, the information can not be requested.

In the report explorer panel 3007, the sequence of pages displayed when a report is opened has significance and defines a hierarchical drill down path. In various embodiments of the invention, the drilling down is an action performed on an open page associated with an indicator(s) and category(s) combination. By selecting an instance of a category within the open page, the next page displayed below the currently opened page is automatically opened. This new page is associated with a different category. Data for this different category is then displayed, however only for the selected instance of the category opened previously.

As an example, in FIG. 38, the assignments report 3805 in the hour results collection 3803 in the assignments library 3801 contains the following pages: Holding Company 3808, Parent Company 3809, Division 3810, and Assignment 3811. In the reports explorer panel 3812, the user selects on the holding company page 3808, corresponding to the result panel 3901 shown in FIG. 39. The user now drill downs and selects an instance of the holding company category, in this case, Daimler-Benz. This has two effects. First, on the report panel, a selection is defined on the Holding Company category. Second, the parent company page 3809 is opened because it is the next page in report explorer 3812 displayed under the assignment report 3805. Only results for Daimler-Benz are displayed in the results panel for category parent company. The user can then, if desired, view data of the divisions that belong to a parent company by performing another drill down.

The top right panel in FIG. 4 is the results panel 3007. In this panel, the data from the databases, organized in pages as described above, is displayed. In one embodiment, pages are displayed in three different formats—the standard page, the dimensions page, and the totals page. A report contains either only standard pages, or dimension pages along with an optional totals page.

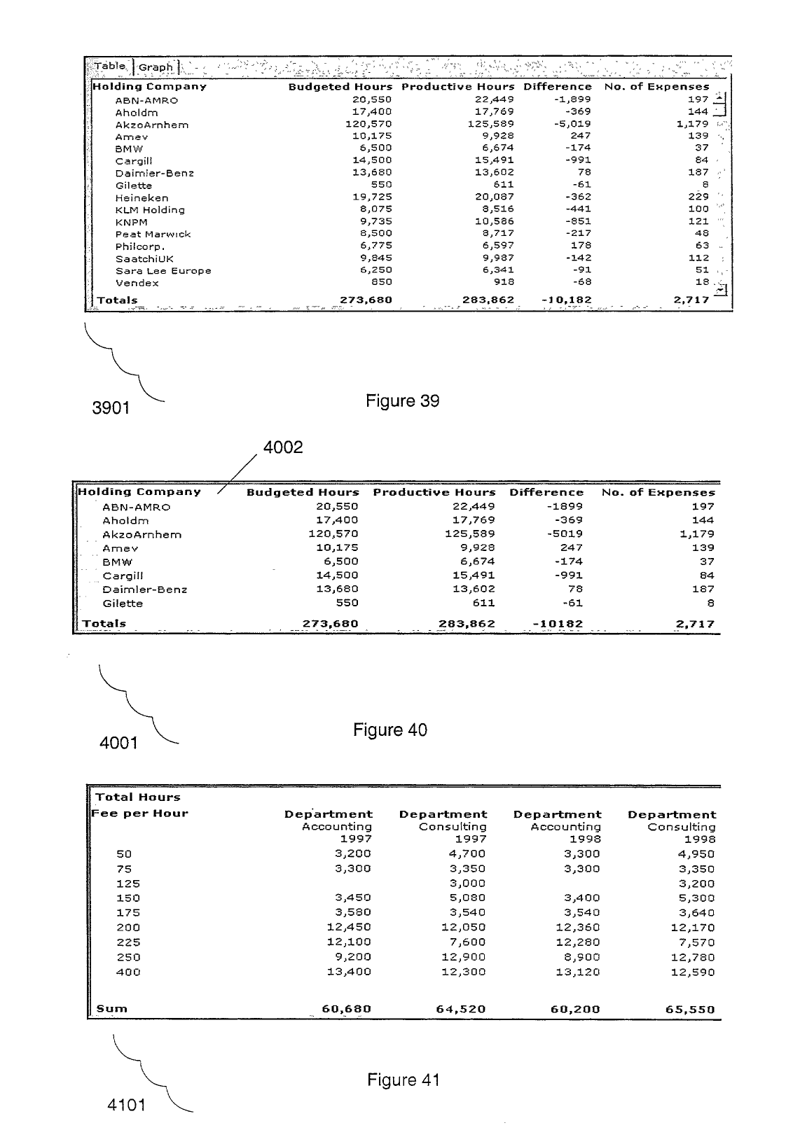

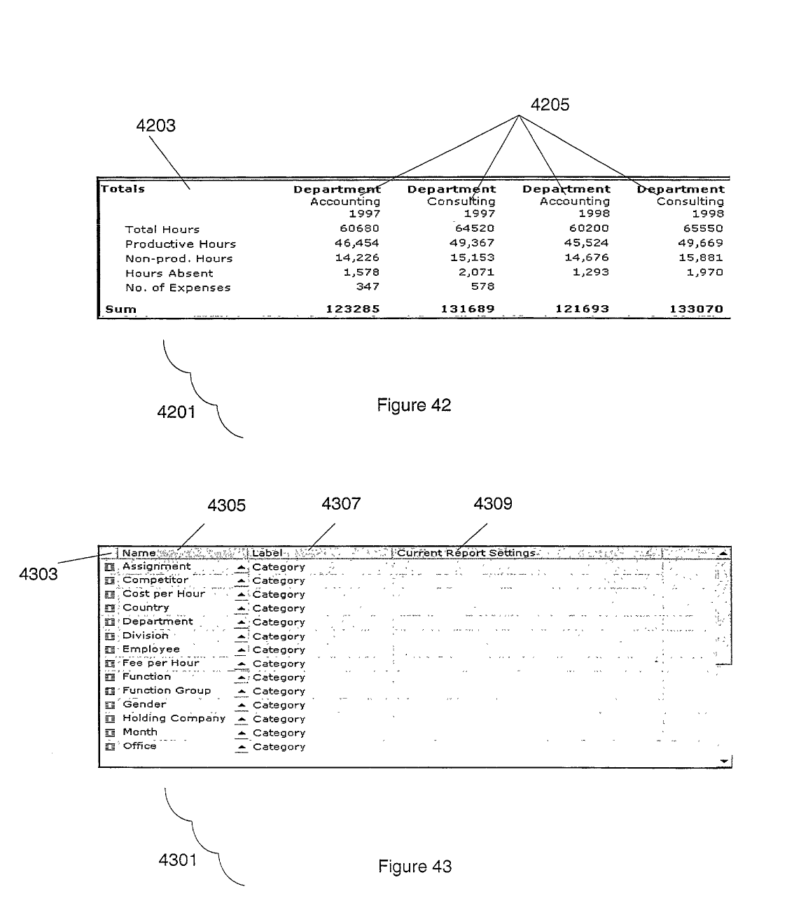

FIG. 40 shows a standard page 4001. The category is displayed on the left, which is the main column 4002. The following columns are indicators. As such, a standard page displays one category, and at least one indicator.

In a dimension page 4101, shown in FIG. 41, several category columns lie along the X-axis, in place of the indicator columns on a standard page. Indicators lie along an imaginary Z-axis. This structure adds an extra dimension to the two-dimensional standard page format in a report. Thus, several lines of inquiry can be set out next to each other in a table. By clicking on the top-most heading, a drop down list appears allowing different indicators to be selected.

A totals page 4201 is associated with the dimension pages in a report. On a totals page 4201, the indicators appear in the main column 4203. All the categories on the dimension pages appear to the right of the main column. The category columns 4205 then give you the totals per indicator.

The report panel 3005 is the bottom right panel in FIG. 4. When a report in report explorer is opened, the report's associated categories and indicators are listed in the report panel 3005. Parameters for a page can be selected using the report panel 3005.

FIG. 43 is a detailed view of the report panel 4301. The report panel 4301 consists of four columns, the icon column 4303, name column 4305, label column 4307, and current reports settings column 4309. In the name column 4305, the names of the available categories and indicators in the report are listed. These categories and indicators are defined by an administrator and are based on a particular business model. The labels column 4307 indicates whether an item is a category or an indicator. The icons 4303 corresponding to category or indicator appear in the first, unnamed column. The current reports settings column 4305 identifies which, if any, category instances for a category have been selected. Selecting a category instance is applicable to drilling down, as described more thoroughly above.

Besides utilizing page view, an end user 206 may interface with the business context engine 201 using monitors 215, as shown in FIG. 5. In various embodiments, as shown in FIG. 6, upon a user requesting a monitor 215, a template, created by an administrator 212, is assigned at the server 208. A request for the data required to fill in the template is forwarded to the business context engine 201. Upon receiving the request for data, the business context engine 201 maps the request to the database using the business model, whereupon the multiple sources are queried 210 and the data retrieved. The retrieved data is then moved into the template at the server 208, and sent to the client 219 where it is rendered.

As opposed to page view, a monitor 215 containing information is initially displayed at the client browser 207 (FIG. 6) without requiring that the user 206 request a particular category/indicator combination. Rather, the monitor 215 displays information based on categories and indicators that have been predefined and typically customized for an end user 206 by an administrator 211. Furthermore, through business logic contained in the business context engine 201, a monitor 215 displays a trend marker which displays status of information displayed, that pertains to at least one category/indicator combination.

FIG. 5 shows a detailed view of a monitor, 3102 containing trend markers 3104. Trend markers 3104 may be based on a mathematical function which is associated with, but not limited to, a plurality of categories or indicators. In various embodiments, the trend marker 3104 indicates whether information displayed has exceeded a threshold, or changed over a period of time. Upon selecting a trend marker 3104, or alternatively the category instance associated with the trend marker 3104, the user is able to drill down on the category instance to acquire more detailed information. This detailed information is displayed at the client browser 207 (FIG. 6) in a new monitor.

When a trend marker is selected by a user, a request for data associated with the trend marker and corresponding category instance is sent to the server 208. This request for data is associated with a new template for generating another monitor 215. A request for the information required to fill in the new template is sent to the business context engine 201. The business context engine 201 retrieves the required information utilizing the business model. The retrieved data is sent to the server 208, moved into the template, and forwarded to the client 219 for rendering. The new monitor displayed may contain additional trend markers, allowing the user to drill down even further for associated data.

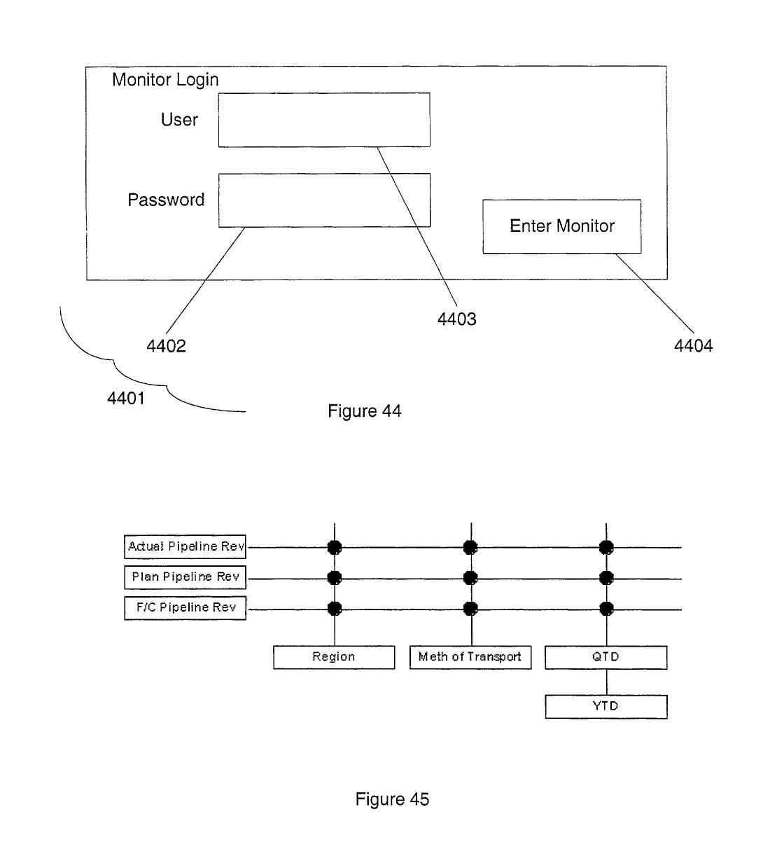

An example of how monitors are utilized by an end user is presented hereafter. FIG. 44 is a display 4401 which allows a user on a client browser to log in, by entering a user name 4403 and password 4402, to the data system and simultaneously request a personalized monitor 4404, in accordance with one embodiment of the invention. A monitor 3102, shown in FIG. 5, is then displayed on the user's client browser. In FIG. 45, the business model associated with the monitor 3102 is shown. The monitor 3102 displays the category “method of transportation” in the left column 3103, and indicators 3105 “planned pipeline revenue”, “actual pipeline revenue”, and “forecasted pipeline revenue” in the adjacent columns, respectively. Additionally, on the right column of the monitor 3102, trend markers 3104 are displayed, which indicate whether the difference between actual revenue and planned revenue exceeds a predefined threshold defined by the administrator.

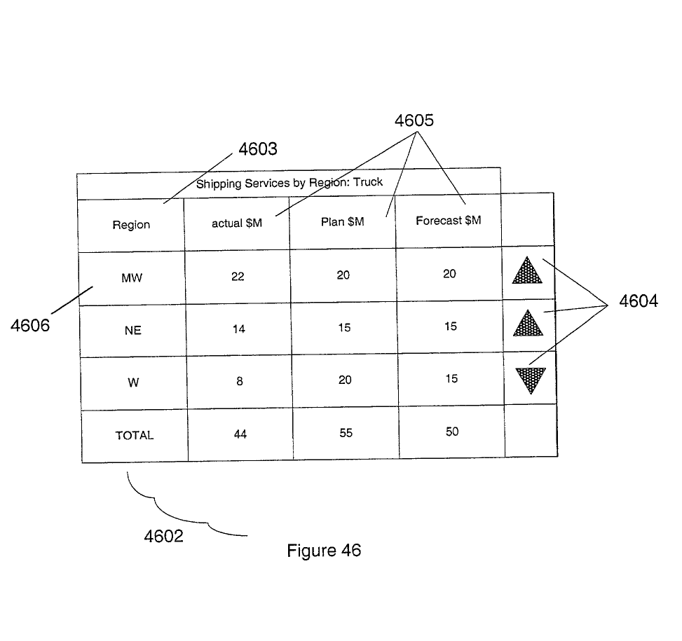

The user drills down by selecting the category instance “truck” 3106, whereupon a request for data corresponding to this instance and trend marker is sent to the server and associated with a new template. The data needed to fill in this template is retrieved from the business context engine 201 using the business model, moved into the template, and sent from the server 208 to the client 219 where it is rendered as a new monitor 215, as shown in FIG. 6. The new monitor, shown in FIG. 46, displays the category “region” 4603 in the left column, and the previously displayed revenue indicators 4605 in the following columns, with data shown limited to category instance “truck”. New trend markers are shown in the far right column 4604. The new monitor allows the user to perform further drill downs.

In an alternative embodiment, the disclosed method may be implemented as a computer program product for use with a computer system. Such implementation may include a series of computer instructions fixed either on a tangible medium, such as a computer readable media (e.g., a diskette, CD-ROM, ROM, or fixed disk) or transmittable to a computer system, via a modem or other interface device, such as a communications adapter connected to a network over a medium. Medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable media with accompanying printed or electronic documentation (e.g., shrink wrapped software), preloaded with a computer system (e.g., on system ROM or fixed disk), or distributed from a server or electronic bulletin board over the network (e.g., the Internet or World Wide Web).

Although various exemplary embodiments of the invention have been disclosed, it should be apparent to those skilled in the art that various changes and modifications can be made which will achieve some of the advantages of the invention without departing from the true scope of the invention. These and other obvious modifications are intended to be covered by the appended claims.

What is claimed is:

1. A method for presenting business data using a computer system, the method comprising:
associating business data of at least one enterprise with a business model, the business model having at least one indicator Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Iᵢ may be pertinent, wherein for each pair {Iᵢ, Cⱼ there may exist a parameter Pᵢⱼ derivable from the business data, that is susceptible to change over time, and wherein a parameter set S={. . . , Pᵢⱼ, . . . } for all values of i and j for which a parameter Pᵢⱼ exists; and
in a first computer process distinct from any financial accounting processes of the at least one enterprise, and pursuant to a query that defines a result subset {. . . , Pᵣₛ, . . . }, rεA, sεB, of the parameter set S,
using the business data to derive values Pᵣₛ for all values of r and s.

2. A method according to claim 1, operating in a network environment wherein associating and using are performed on a server, the query having been received from a client.

3. The method according to claim 2, wherein the network environment is the Internet.

4. A method according to claim 1, further comprising:
in a second computer process, outputting to a network device information derived from the values Pᵣₛ permitting the display of the information at the network device.

5. A method according to claim 4, wherein outputting includes permitting the display of the information in a format that allows selectable display of parameters.

6. A method according to claim 5, wherein outputting includes permitting the display of the information in a format that allows selectable display, according to hierarchical level, of data from which the information is derived.

7. A method according to claim 6, wherein outputting includes permitting the display of the information in a format that permits, for a displayed value Pᵣₛ, selecting an instance of Cₛ, whereby data of a category hierarchically related to the instance of Cₛ is displayed as it pertains to indicator Iᵣ.

8. A method according to claim 4, further comprising:
performing the first and second processes repetitively, so that the information displayed is updated on each repetition.

9. A method according to claim 4, wherein outputting includes permitting the display of a graphical indication of a current trend in a parameter.

10. A method according to claim 9, wherein, the graphical indication is used for graphical control.

11. A method according to claim 10, wherein, graphical control is actuated by graphically selecting the graphical indication.

12. A method according to claim 10, wherein, the graphical indication allows for graphical control depending on the trend displayed by the graphical indication.

13. A method according to claim 10, wherein, the graphical indication controls a drill down.

14. A method according to claim 1, further comprising:
associating with the business model a template for displaying information, the template including an arrangement for displaying data in a format that permits selectable display of related data from which the information is derived.

15. A method according to claim 14, further comprising:
transmitting the template with the information to a network device via a network for display of the template in a browser.

16. A method according to claim 4, wherein in outputting, the information that is permitted to be displayed includes a graphical representation of the information derived from parameter values Pᵣₛ.

17. A method according to claim 4, wherein in outputting, the information that is permitted to be displayed includes a numerical representation of the information derived from parameter values Pᵣₛ.

18. A method according to claim 4, wherein in outputting, the information that is permitted to be displayed includes an auditory representation of information derived from parameter values Pᵣₛ.

19. A method according to claim 4, wherein in outputting, the information that is permitted to be displayed includes a textual representation of the information derived from parameter values Pᵣₛ.

20. A method according to claim 1, further comprising:
creating the business model using an architect module, wherein the step of creating the business model includes:
entering the at least one indicator Iᵢ (iεA, A={1, . . . , m, m a non-zero integer}) and the at least one category Cⱼ (jεB, B={1, . . . , n, n a non-zero integer}) to form a two dimensional grid with the at least one indicator Iᵢ located on a first axis of the grid and the at least one category Cⱼ located on a second axis of the grid, so that each node on the two dimensional grid represents a pair {Iᵢ, Cⱼ},
entering connections on the nodes of the grid for each pair {Iᵢ, Cⱼ} having a parameter Pᵢⱼ that is in the parameter set S;
defining available databases; and
mapping the at least one indicator, the at least one category, and the at least one connection to the available databases.

21. A method for presenting business data using a computer system, the method comprising:
associating business data of at least one enterprise with a business model, the business model having at least one indicator Iᵢ (iεA, A={1. . . , , m, m a non-zero integer}) pertinent to performance of a business and at least one category Cⱼ (jεB, B={1, . . . , n, n a non-zero integer}) identifying an aspect of the business to which the indicator Iᵢ may be pertinent, wherein for each category and indicator value combination V=V_{I}∪V_{C}, where V_{I}={. . . , I_{α}, . . . } where αεA and V_{C}={. . . , C_{β},. . . } where βεB, there may exist a parameter P_{V}, derivable from the business data, that is susceptible to change over time, and wherein there exists a parameter set S={. . . , P_{V}, . . . } for all V for which a parameter P_{V} exists; and
in a first computer process of the at least one enterprise, and pursuant to a query that defines a result subset {. . . , P_{W}, . . . } of the parameter set S, where W is an element of the set of all V's for which a parameter P_{V} exists, using the business data to derive parameter values P_{W}.

22. A method according to claim 21, further comprising:
in a second computer process, outputting to a network device information derived from the values P_{W} permitting the display of the information at the network device.

23. A computer system for presenting business data, the system comprising:
a business context engine for associating the business data of at least one enterprise with a business model, the business model having at least one indicator Iᵢ (iεA, A={1,. . . , m, m a non-zero integer}) pertinent to performance of a business and at least one category Cⱼ (jεB, B {1, . . . , n, n a non-zero integer}) identifying an aspect of the business to which the indicator Iᵢ may be pertinent, wherein for each pair {Iᵢ, Cⱼ} there may exist a parameter Pᵢⱼ derivable from the business data, that is susceptible to change over time, and wherein there exists a parameter set S={. . . , } for all values of i and j for which a parameter Pᵢⱼ exists;
wherein the business context engine, in a computer process distinct from any financial accounting processes of the at least one enterprise, and pursuant to a query that defines a result subset {. . . , Pᵣₛ, . . . }, rεA, sεB, of the parameter set S, uses the business data to derive parameter values Pᵣₛ for all values of r and s.

24. A computer system according to claim 23, operating in a network environment wherein the query is received from a network device on a network.

25. A computer system according to claim 24, wherein the network environment is the Internet.

26. A computer system according to claim 23, further comprising a gateway, the gateway causing the display of information derived from parameter values Pᵣₛ at a network device.

27. A computer system according to claim 26, wherein the gateway causes the display of information in a format that permits drill down.

28. A computer system according to claim 27, wherein the gateway causes the display of information in a format that permits selectable display, according to hierarchical level, of data from which the information is derived.

29. A computer system according to claim 28, wherein the gateway causes the display of information in a format that permits, for a displayed Pᵣₛ, selecting an instance of C_{S}, whereby data of a category hierarchically related to the instance of C_{S} is displayed as it pertains to indicator Iᵣ.

30. A computer system according to claim 26, wherein the gateway inserts the parameter values into a template prior to sending the template to the network device.

31. A computer system according to claim 26, wherein the gateway causes the display of a graphical indication of a current trend in a parameter.

32. A computer system according to claim 31, wherein the graphical indication is used for graphical control.

33. A computer system according to claim 32, wherein the graphical indication is graphically selectable.

34. A computer system according to claim 32, wherein the graphical indication is used for graphical control depending on the trend displayed by the graphical indication.

35. A computer system according to claim 32, wherein the graphical indication controls drill down.

36. A computer system according to claim 23, further comprising:
a template associated with the business model for displaying information, the template including an arrangement for displaying data in a format that permits selectable display of related data from which the information is derived.

37. A computer system according to claim 36, wherein the template is transmitted with information to a network device via a network for display of the template in a browser.

38. A computer system according to claim 26, wherein the gateway causes the display, at the network device, of graphical representation of the information derived from parameter values Pᵣₛ.

39. A computer system according to claim 26, wherein the gateway causes the display, at the network device, of a numerical representation of the information derived from parameter values Pᵣₛ.

40. A computer system according to claim 26, wherein the gateway sends to a network device an auditory representation of information derived from parameter values Pᵣₛ.

41. A computer system according to claim 26, wherein the gateway causes the display, at the network device, of a textual representation of the information derived from parameter values Pᵣₛ.

42. A computer system according to claim 23, further comprising:
an architect module for creating the business model, wherein the architect module provides for:
entering the at least one indicator Li and the at least one category Cⱼ to form a two dimensional grid with the at least one indicator Iᵢ located on a first axis of the grid and the at least one category Cⱼ located on a second axis of the grid, so that each node on the two dimensional grid represents a pair {Iᵢ, Cⱼ}.

43. A computer system for presenting business data, the system comprising:
a business context engine for associating business data of at least one enterprise with a business model, the business model having at least one indicator Iᵢ (iεA, A={1, . . . , m, m a non-zero integer}) pertinent to performance of a business and at least one category Cⱼ (jεB, B=1,. . . , n, n a non-zero integer}) identifying an aspect of the business to which the indicator Iᵢ may be pertinent, wherein for each category and indicator value combination V=V_{I}∪V_{C}, where V_{I}={. . . , I_{α}, . . . } where a αε and V_{C}={. . . , C_{β}. . . }, where , βεB, there may exist a parameter P_{V}, derivable from the business data, that is susceptible to change over time, and wherein there exists a parameter set S={. . . , P_{V}, . . . } for all V for which a parameter P_{V} exists; and
in a first computer process of the at least one enterprise, and pursuant to a query that defines a result subset {. . . , P_{W}, . . . } of the parameter set S, where W is an element of the set of all V's for which a parameter P_{V} exists, using the business data to derive parameter values P_{W}.

44. A computer system according to claim 21, further comprising a gateway, wherein the gateway causes the display of information derived from parameter values P_{W} at a network device.

45. A computer program product for use on a computer system for presenting business data, the computer program product comprising a computer usable medium having computer readable program code thereon, the computer readable program code including:
computer code for associating business data of at least one enterprise with a business model, the business model having at least one indicator Iᵢ (iεA, A={1, . . . , m, m a non-zero integer}) pertinent to performance of a business and at least one category Cⱼ (jεB, B={1. . . , n, n a non-zero integer}) identifying an aspect of the business to which the indicator Iᵢ may be pertinent, wherein for each pair {Iᵢ, Cⱼ} there may exist a parameter Pᵢⱼ, derivable from the business data, that is susceptible to change over time, and wherein a parameter set S={. . . , Pᵢⱼ, . . . } for all values of i and j for which a parameter Pᵢⱼ exists; and
computer code for, in a first computer process distinct from any financial accounting processes of the at least one enterprise, and pursuant to a query that defines a result subset {. . . , Pᵣₛ, . . . }, rεA, sεB, of the parameter set S, using the business data to derive values Pᵣₛ for all values of r and s.

46. A computer program product according to claim 45 operating in a network environment wherein the computer code program for associating business data and the program code for using the business data to derive values of Pᵣₛ is operating on a server, the query having been received from a network device.

47. A computer program product according to claim 46, wherein the network environment is the Internet.

48. A computer program product according to claim 45, further comprising:
computer code for outputting to a network device information derived from the values Pᵣₛ permitting display of the information at the network device.

49. A computer program product according to claim 48, wherein the display of the information includes a format that permits drill down.

50. A computer program product according to claim 49, wherein the display of the information includes displaying in a format that permits selectable display, according to hierarchical level, of data from which the information is derived.

51. A computer program product method according to claim 50, wherein the display of the information includes displaying data in a format that permits, for a displayed value Pᵣₛ, selecting an instance of C_{S}, whereby data of a category hierarchically related to the instance of C_{S} is displayed as it pertains to indicator Iᵣ.

52. A computer program product according to claim 48, further comprising computer code for performing using and outputting repetitively, so that the information displayed is updated on each repetition.

53. A computer program product according to claim 48, wherein the display of information includes a graphical indication of a current trend in a parameter.

54. A computer program product according to claim 53, wherein the graphical indication is used for graphical control.

55. A computer program product according to claim 54, wherein graphical control is actuated by graphically selecting the graphical indication.

56. A computer program product according to claim 54, wherein the graphical indication is used for graphical control depending on the trend displayed by the graphical indication.

57. A computer program product according to claim 54, wherein the graphical indication controls drill down.

58. A computer program product according to claim 45, further comprising:
program code for associating with the business model a template for displaying information, the template including an arrangement for displaying data in a format that permits selectable display of related data from which the information is derived.

59. A computer program product according to claim 58, further comprising:
program code for transmitting the template with information to a network device via a network for display of the template in a browser.

60. A computer program product according to claim 48, wherein the display of information includes a graphical representation of the information derived from parameter values Pᵣₛ.

61. A computer program product according to claim 48, wherein the display of information includes a numerical representation of the information derived from parameter values Pᵣₛ.

62. A computer program product according to claim 48, wherein the display of information includes an auditory representation of information derived from parameter values Pᵣₛ.

63. A computer program product according to claim 48, wherein displaying information includes a textual representation of the information derived from parameter values Pᵣₛ.

64. A computer program product according to claim 45, further comprising:
computer code for creating the business model using an architect module, the computer code comprising:
program code for entering the at least one indicator Iᵢ (iεA, A={1, . . . , m, m a non-zero integer}) and the at least one category Cⱼ (jεB, B={1, . . . , n, n a non-zero integer}) to form a two dimensional grid with the at least one indicator Iᵢ located on a first axis of the grid and the at least one category Cⱼ located on a second axis of the grid, so that each node on the two dimensional grid represents a pair {Iᵢ, Cⱼ},
program code for entering connections on the nodes of the grid for each pair {Iᵢ, Cⱼ} having a parameter Pᵢⱼ that is in the parameter set S;
program code for defining available databases; and
program code for mapping the at least one indicator, the at least one category, and the at least one connection to the available databases.

65. A computer program product for use on a computer system for presenting business data, the computer program product comprising a computer usable medium having computer readable program code thereon, the computer readable program code including:
computer code for associating business data of at least one enterprise with a business model, the business model having at least one indicator Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Iᵢ may be pertinent, wherein for each category and indicator value combination V=V_{I}∪V_{C}, where V_{I}={. . . , I_{α}. . . } where αεA and V_{C}={. . . , C_{β}, . . . } where βεB, there may exist a parameter P_{V}, derivable from the business data, that is susceptible to change over time, and wherein there exists a parameter set S={. . . , P_{V}, } for all V for which a parameter P_{V} exists; and
program code for, in a first computer process of the at least one enterprise, and pursuant to a query that defines a result subset {. . . , P_{W}, } of the parameter set S, where W is an element of the set of all V's for which a parameter P_{V} exists,
using the business data to derive parameter values P_{W}.

66. A computer program product according to claim 65, further comprising:
program code for causing the display of information derived from parameter values P_{W}.

67. A method for creating a business model using an architect module, the model based on business data of at least one enterprise, the method comprising:
entering at least one indicator Iᵢ (iεA, A={1, . . . , m, m a non-zero integer}) pertinent to performance of a business and at least one category Cⱼ (jεB, B={1, . . . , n, n a non-zero integer}) identifying an aspect of the business to which the indicator Iᵢ may be pertinent, to form a two dimensional grid with the at least one indicator Iᵢ located on a first axis of the grid and the at least one category Cⱼ located on a second axis of the grid, so that each node on the two dimensional grid represents a pair {Iᵢ, Cⱼ}.

68. A method according to claim 67, further comprising:
entering connections on the nodes of the grid for each pair {Iᵢ, Cⱼ} having a parameter Pᵢⱼ derivable from the business data.

69. A method according to claim 68, further comprising:
defining available databases.

70. A method according to claim 69, further comprising:
mapping the at least one indicator, the at least one category, and the at least one connection to the available databases.

71. A method for presenting business data using a computer system, the method comprising:
associating business data, which need not be part of a single data structure in any format, of at least one enterprise with a business model, the business model having at least one indicator pertinent to performance of a business and at least one category identifying an aspect of the business to which the indicator may be pertinent, wherein for each pair of indicator and category there may exist a parameter, derivable from the business data and not necessarily pre-existing in such business data;
and in a first computer process, and pursuant to a query that defines one or more indicator-category pairs,
using the business data to derive values of one or more parameters corresponding to the one or more indicator-category pairs in the query.

72. A method according to claim 71, operating in a network environment wherein associating and using are performed on a server, the query having been received from a client.

73. The method according to claim 72, wherein the network environment is the Internet.

74. A method according to claim 71, further comprising:
in a second computer process, outputting to a network device information derived from the values Pᵣₛ permitting the display of the information at the network device.

75. A method according to claim 74, wherein outputting includes permitting the display of the information in a format that allows selectable display of data.

76. A method according to claim 75, wherein outputting includes permitting the display of the information in a format that allows selectable display, according to hierarchical level, of data from which the information is derived.

77. A method according to claim 76, outputting includes permitting the display of the information in a format that permits, for a parameter, selecting an instance of a category, whereby data of a related category to the instance of the category is displayed.

78. A method according to claim 74, wherein displaying the one or more parameters further comprising:
performing the first and second processes repetitively, so that the one or more parameters displayed are updated on each repetition.

79. A method according to claim 74, wherein outputting includes permitting the display of a graphical indication of a current trend of a parameter.

80. A method according to claim 79, wherein, the graphical indication is used for graphical control.

81. A method according to claim 80, wherein, graphical control is actuated by graphically selecting the graphical indication.

82. A method according to claim 80, wherein, the graphical indication is used for graphical control depending on the trend displayed by the graphical indication.

83. A method according to claim 80, wherein, the graphical indication controls drill down.

84. A method according to claim 71, further comprising:
associating with the business model a template for displaying the one or more parameters, the template including an arrangement for displaying data in a format that permits selectable display of related data from which the one or more parameters are derived.

85. A method according to claim 84, further comprising:
transmitting the template with the parameters to a network device via a network for display of the template in a browser.

86. A method according to claim 71, further comprising:
creating the business model using an architect module, wherein the step of creating the business model includes:
entering the at least one indicator and the at least one category to form a two dimensional grid with the at least one indicator located on a first axis of the grid and the at least one category located on a second axis of the grid, so that each node on the two dimensional grid represents a category-indicator pair.

87. A computer program product for use on a computer system for presenting business data, the computer program product comprising a computer usable medium having computer readable program code thereon, the computer readable program code including:
computer code for associating business data, which need not be part of a single data structure in any format, of at least one enterprise with a business model, the business model having at least one indicator pertinent to performance of a business and at least one category identifying an aspect of the business to which the indicator may be pertinent, wherein for each pair of indicator and category there may exist a parameter, derivable from the business data and not necessarily pre-existing in such business data; and
computer code pursuant to a query defining one or more indicator-category pairs, computer code which uses the business data to derive values of one or more parameters corresponding to the one or more indicator-category pairs in the query.

88. The computer program product according to claim 87, further comprising:
computer code for operating in a network environment, wherein the query having been received from a network device.

89. The computer program product according to claim 88, wherein the computer code for operating in a network environment is operational for the Internet.

90. A computer program product according to claim 87, further comprising:
computer code for causing the display of the one or more values of the one or more parameters corresponding to the one or more indicator-category pairs in the query at a network device.

91. A computer program product according to claim 90, wherein the computer code for causing the display includes causing the display in a format that permits selectable display of data.

92. A computer program product according to claim 91, wherein the computer code for causing the display includes computer code for causing the display in a format that permits selectable display, according to hierarchical level, of data from which the one or more parameters are derived.

93. A computer program product according to claim 91, wherein the computer code for displaying information includes computer code for displaying in a format that permits, for a parameter, selecting an instance of a category, whereby data of a related category to the instance of the category is displayed.

94. A computer program product according to claim 91, wherein the computer code for causing the display of the one or more parameters includes causing the display of a graphical indication of a current trend in a parameter.

95. A computer program product according to claim 94, wherein the computer code for causing the display, further includes computer code for allowing the graphical indication to provide graphical control.

96. A computer program product according to claim 94, wherein the computer code for causing the display, further includes computer code for providing graphical control by graphical selection of the graphical indication.

97. A computer program product according to claim 94, wherein the computer code for causing the display, further includes computer code for providing graphical control depending on the trend displayed by the graphical indication.

98. A computer program product according to claim 94, wherein the computer code for causing the display, further includes computer code for allowing graphical selection of the graphical indication providing drill down.

99. A computer program product according to claim 87, further comprising:
computer code for associating with the business model a template for displaying the one or more parameters, the template including an arrangement for displaying data in a format that permits selectable display of related data from which the one or more parameters are derived.

100. A computer program product according to claim 99, further comprising:
computer code for transmitting the template with the parameters to a client via a network for display of the template in a browser.

101. An apparatus for presenting business data, the apparatus comprising:
a business context engine which associates business data, which need not be part of a single data structure in any format, of at least one enterprise with a business model, the business model having at least one indicator pertinent to performance of a business and at least one category identifying an aspect of the business to which the indicator may be pertinent, wherein for each pair of indicator and category there may exist a parameter, derivable from the business data and not necessarily pre-existing in such business data;
wherein pursuant to a query that defines one or more indicator-category pairs, the business context engine uses the business data to derive values of one or more parameters corresponding to the one or more indicator-category pairs in the query.

102. The apparatus according to claim 101, operational in a network environment.

103. The apparatus according to claim 102, wherein the network environment is the Internet.

104. The apparatus according to claim 101, further comprising:
a gateway for creating an output having information derived from the parameters and transmitting to a network device the output, wherein the output permits the display of the information at a network device.

105. The apparatus according to claim 104, wherein the output created by the gateway further includes data which permits the display of the information in a format that allows selectable display of the information.

106. An apparatus according to claim 105, wherein the output created by the gateway further includes data which permits the display of the information in a format that allows selectable display, according to hierarchical level, of data from which the information is derived.

107. An apparatus according to claim 106, outputting includes permitting the display of the information in a format that permits, for a parameter, selecting an instance of a category, whereby data of a related category to the instance of the category is displayed.

108. An apparatus according to claim 104, wherein the output created by the gateway further includes data which permits the display of a graphical indication of a current trend of a parameter.

109. The apparatus according to claim 108, wherein, the graphical indication is used for graphical control.

110. The apparatus according to claim 109, wherein, graphical control is actuated by graphically selecting the graphical indication.

111. The apparatus according to claim 108, wherein, the graphical indication is used for graphical control depending on the trend displayed by the graphical indication.

112. The apparatus according to claim 108, wherein, the graphical indication controls drill down.

113. The apparatus according to claim 101, further comprising:
a gateway for associating with the business model a template for displaying the one or more parameters, the template including an arrangement for displaying data in a format that permits selectable display of related data from which the one or more parameters are derived.

114. The apparatus according to claim 113, further comprising:
transmitting the template with the parameters to a client via a network for display of the template in a browser.

115. A method for presenting business data using a computer system, the method comprising:
providing a business model, the business model having at least one indicator pertinent to performance of a business and at least one category identifying an aspect of the business to which the indicator may be pertinent, wherein for each pair of indicator and category there may exist a parameter, derivable from sources in business data of at least one enterprise, the business data not needing to be part of a single data structure in any format, the parameter not necessarily pre-existing in such data;
providing, in connection with the business model, paths to the sources in the data for determining the parameter for each indicator-category pair;
receiving a query that defines one or more indicator-category pairs with respect to each of which a corresponding parameter value is desired; and
using the business model to derive the corresponding parameter value.

116. A method according to claim 115, operating in a network environment wherein associating and using are performed on a server, the query having been received from a client.

117. The method according to claim 116, wherein the network environment is the Internet.

118. A method according to claim 115, further comprising:
outputting to a network device an output having information derived from the corresponding parameter value, the output permitting the display of the information at the network device.

119. A method according to claim 118, wherein, in outputting, the output permits the display of the information in a format that allows selectable display of data.

120. A method according to claim 118, wherein, in outputting, the output permits the display of the information in a format that allows selectable display, according to hierarchical level of data from which the information is derived.

121. A method according to claim 118, wherein, in outputting, the output permits the display of the information in a format that allows, for a parameter, selecting an instance of a category, whereby data of a related category to the instance of the category is displayed.

122. A method according to claim 118, wherein, in outputting, the output permits the display of a graphical indication of a current trend of a parameter.

123. A method according to claim 122, wherein, the graphical indication is used for graphical control.

124. A method according to claim 123, wherein, graphical control is actuated by graphically selecting the graphical indication.

125. A method according to claim 123, wherein, the graphical indication is used for graphical control depending on the trend displayed by the graphical indication.

126. A method according to claim 123, wherein, the graphical indication controls display of related data.

127. A method according to claim 115, further comprising:
associating with the business model a template for displaying the one or more parameters, the template including an arrangement for displaying data in a format that permits selectable display of related data from which the one or more parameters are derived.

128. A method according to claim 126, further comprising:
transmitting the template with the parameters to a client via a network for display of the template in a browser.

129. A computer program product for use on a computer system for presenting business data, the computer program product comprising a computer usable medium having computer readable program code thereon, the computer readable program code including:
computer code providing a business model, the business model having at least one indicator pertinent to performance of a business and at least one category identifying an aspect of the business to which the indicator may be pertinent, wherein for each pair of indicator and category there may exist a parameter, derivable from sources in business data of at least one enterprise, the business data not needing to be part of a single data structure in any format, the parameter not necessarily pre-existing in such data;
computer code providing, in connection with the business model, paths to the sources in the data for determining the parameter for each indicator-category pair;
computer code for receiving a query that defines one or more indicator-category pairs with respect to each of which a corresponding parameter value is desired; and
computer code for using the business model to derive the corresponding parameter value.

130. The computer program product according to claim 129, further comprising:
computer code for operating in a network environment, wherein the query having been received from a network device.

131. The computer program product according to claim 130, wherein the computer code for operating in a network environment has computer code for operating with the Internet.

132. The computer program product according to claim 129, further comprising:
computer code for causing the display of the one or more values of the one or more parameters corresponding to the one or more indicator-category pairs in the query at a network device.

133. The computer program product according to claim 132, wherein the computer code for causing the display includes computer code for causing the display in a format that permits drill down.

134. A computer program product according to claim 132, wherein the computer code for causing the display includes computer code for causing the display in a format that permits selectable display according to hierarchical level, of data from which the one or more parameters are derived.

135. A computer program product according to claim 132, wherein the computer code for displaying information includes computer code for displaying in a format that permits, for a parameter, selecting an instance of a category, whereby data of a related category to the instance of the category is displayed.

136. A computer program product according to claim 132, wherein the computer code for causing the display of the one or more values of the one or more parameters includes causing the display of a graphical indication of a current trend in a parameter.

137. A computer program product according to claim 136, wherein the computer code for causing the display, further includes computer code for allowing the graphical indication to provide graphical control.

138. A computer program product according to claim 137, wherein the computer code for causing the display, further includes computer code for providing graphical control by graphical selection of the graphical indication.

139. A computer program product according to claim 137, wherein the computer code for causing the display, further includes computer code for providing graphical control depending on the trend displayed by the graphical indication.

140. A computer program product according to claim 139, wherein the computer code for causing the display, further includes computer code for allowing graphical selection of the graphical indication providing drill down.

141. Method for presenting data derived from one or more databases, which need not be part of a single data structure of a specific format, the method comprising:
providing a model, the model having at least one indicator and at least one category to which the indicator may be pertinent, wherein for each pair of indicator and category there may exist a parameter, derivable from sources in the one or more data bases, the parameter not necessarily pre-existing therein,
providing a link by a model engine to the sources for determining the parameter for each indicator-category pair;
receiving a query that defines one or more indicator-category pairs with respect to each of which a corresponding parameter value is desired;
using the model engine to access the sources by a query engine and to derive from the sources each corresponding parameter value;
and outputting each corresponding parameter value to a network device.

142. A method according to claim 141, wherein outputting includes permitting the display of the information in a format that allows selectable display of data.

143. A method according to claim 142, wherein outputting includes permitting the display of the information in a format that allows selectable display, according to hierarchical level, of data from which the information is derived.

144. A method according to claim 141, outputting includes permitting the display of the information in a format that permits, for a parameter, selecting an instance of a category, whereby data of a related category to the instance of the category is displayed.

145. A method according to claim 141, wherein outputting includes permitting the display of a graphical indication of a current trend of a parameter.

146. A method according to claim 145, wherein, the graphical indication is used for graphical control.

147. A method according to claim 146, wherein, graphical control is actuated by graphically selecting the graphical indication.

148. A method according to claim 145, wherein, the graphical indication is used for graphical control depending on the trend displayed by the graphical indication.

149. A method according to claim 139, wherein, the graphical indication controls drill down.

150. A method according to claim 141, further comprising:
associating with the model a template for displaying the one or more parameters, the template including an arrangement for displaying data in a format that permits selectable display of related data from which the one or more parameters are derived.

151. A method according to claim 152, wherein outputting further comprises:
transmitting the template with the parameters to a network device via a network for display of the template in a browser.

152. A computer program product for use on a computer system for presenting business data, the computer program product comprising a computer usable medium having computer readable program code thereon, the computer readable program code including:
computer code for providing a model, the model having at least one indicator and at least one category to which the indicator may be pertinent, wherein for each pair of indicator and category there may exist a parameter, derivable from sources in the one or more data bases, the parameter not necessarily pre-existing therein,
computer code providing a link by a model engine to the sources for determining the parameter for each indicator-category pair;
computer code for receiving a query that defines one or more indicator-category pairs with respect to each of which a corresponding parameter is desired;
computer code using the model engine to access the sources by a query engine and to derive from the sources each corresponding parameter; and
computer code for outputting each corresponding parameter to a network device.

153. A computer program product according to claim 152, further comprising:
computer code for causing the display of each corresponding parameter corresponding parameter at the network device.

154. A computer program product according to claim 153, wherein the computer code for causing the display includes causing the display in a format that permits drill down.

155. A computer program product according to claim 153, wherein the computer code for causing the display includes computer code for causing the display in a format that permits selectable display, according to hierarchical level, of data from which each corresponding parameter is derived.

156. A computer program product according to claim 153, wherein the computer code for displaying information includes computer code for displaying in a format that permits, for a corresponding parameter, selecting an instance of a category, whereby data of a related category to the instance of the category is displayed.

157. A computer program product according to claim 153, wherein the computer code for causing the display of the one or more parameters includes causing the display of a graphical indication of a current trend in a parameter.

158. A computer program product according to claim 157, wherein the computer code for causing the display, further includes computer code for allowing the graphical indication to provide graphical control.

159. A computer program product according to claim 158, wherein the computer code for causing the display, further includes computer code for providing graphical control by graphical selection of the graphical indication.

160. A computer program product according to claim 159, wherein the computer code for causing the display, further includes computer code for providing graphical control depending on the trend displayed by the graphical indication.

161. A computer program product according to claim 152, further comprising:
computer code for associating with the business model a template for displaying each corresponding parameter, the template including an arrangement for displaying data in a format that permits selectable display of related data from which each corresponding parameter is derived.

162. A system for presenting data derived from one or more databases comprising:
a model, the model having at least one indicator and at least one category to which the indicator may be pertinent, wherein for each pair of indicator and category there may exist a parameter, derivable from sources in the one or more data bases, the parameter not necessarily pre-existing therein;
a projection engine receiving a user query that defines one or more indicator-category pairs with respect to each of which a corresponding parameter value is desired;
a model engine for mapping the user query to the model and providing a link between the model and the sources; and
a query engine for retrieving data from the sources in response to the mapped user query;
wherein the model engine derives from the retrieved data each corresponding parameter value for each indicator-category pair.
